(19) United States
(12) Patent Application Publication
(10) Pub. No.: US 2025/0336165 A1
(43) Pub. Date: Oct. 30, 2025

(54) Generation and Processing of Avatars

(71) Applicant: GENIES, INC., West Hollywood, CA (US)

(72) Inventors: James Jonathan Bancroft, Culver City, CA (US); Akash Raman Nigam, Venice, CA (US); Wayne Tzu-Wen Wu, Los Angeles, CA (US); Davide Munisso, Vancouver (CA); Jingwen Liang, Santa Clara, CA (US)

(21) Appl. No.: 18/650,811

(22) Filed: Apr. 30, 2024

(51) Int. Cl. G06T 19/20; G06T 7/55; G06T 15/04; G06T 15/08; G06T 17/20

(52) U.S. Cl. CPC G06T 19/20; G06T 7/55; G06T 15/04; G06T 15/08; G06T 17/205; G06T 2207/30201; G06T 2210/16; G06T 2210/32; G06T 2219/2016; G06T 2219/2021

(57) ABSTRACT

Provided are methods, systems, devices, apparatuses, and tangible non-transitory computer readable media for processing avatar content that can be used in a virtual environment. The disclosed technology can generate optimized semantic segments based on assets comprising meshes and textures associated with avatars. Further, the disclosed technology can generate hierarchical skeletons, deformable mesh models, and facial expressions on facial regions of the mesh models. Further, the compatibility of avatars with a virtual environment can be determined and compatible avatars and granular assets associated with avatars can be sent to remote computing systems that are configured to implement the avatars.

### FIELD

The present disclosure generally relates to generating and processing avatars that can be used in virtual environments. More particularly, the present disclosure relates to generating skeletal hierarchies and deformable mesh models that are compatible with various virtual environments.

### BACKGROUND

Operations associated with generating and modifying assets for use in a virtual setting can be implemented on a variety of computing devices. These operations can comprise receiving data that is associated with the state of virtual objects that can be represented within the virtual setting. Additionally, the operations can combine different virtual objects and cause the newly formed virtual objects to perform a variety of different actions. However, different types of operations can be performed on the virtual objects. Accordingly, there can be different representations of virtual objects and different implementations can be used to present the virtual objects to users of a virtual setting.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of generating avatars. The computer-implemented method can comprise receiving, by a computing system comprising one or more processors, a plurality of assets associated with a plurality of avatars. The plurality of assets can comprise a plurality of meshes and a plurality of textures. The computer-implemented method can comprise determining, by the computing system, based on inputting the plurality of assets into one or more machine-learning models, a plurality of semantic segments of the plurality of assets. The computer-implemented method can comprise detecting, by the computing system, based on the plurality of meshes and the plurality of textures, one or more segment errors in the plurality of semantic segments. The computer-implemented method can comprise generating, by the computing system, based on the one or more segment errors and the plurality of semantic segments, a plurality of optimized semantic segments.

Another example aspect of the present disclosure is directed to one or more tangible non-transitory computer-readable media storing computer-readable instructions that when executed by one or more processors cause the one or more processors to perform operations. The operations can comprise receiving a plurality of assets associated with a plurality of avatars. The plurality of assets can comprise a plurality of meshes and a plurality of textures. The operations can comprise determining, based on inputting the plurality of assets into one or more machine-learning models, a plurality of semantic segments of the plurality of assets. The operations can comprise detecting, based on the plurality of meshes and the plurality of textures, one or more segment errors in the plurality of semantic segments. The operations can comprise generating, based on the one or more segment errors and the plurality of semantic segments, a plurality of optimized semantic segments.

Another example aspect of the present disclosure is directed to a computing system including: one or more processors; and one or more non-transitory computer-readable media storing instructions that when executed by the one or more processors cause the one or more processors to perform operations. The operations can comprise receiving a plurality of assets associated with a plurality of avatars. The plurality of assets can comprise a plurality of meshes and a plurality of textures. The operations can comprise determining, based on inputting the plurality of assets into one or more machine-learning models, a plurality of semantic segments of the plurality of assets. The operations can comprise detecting, based on the plurality of meshes and the plurality of textures, one or more segment errors in the plurality of semantic segments. The operations can comprise generating, based on the one or more segment errors and the plurality of semantic segments, a plurality of optimized semantic segments.

One example aspect of the present disclosure is directed to a computer-implemented method of generating hierarchical skeletons. The computer-implemented method can comprise receiving, by a computing system comprising one or more processors, a plurality of images of an avatar from a plurality of perspectives. The computer-implemented method can comprise generating, by the computing system, based on inputting the plurality of images into one or more machine-learning models, a plurality of skeletal segments corresponding to the avatar. The computer-implemented method can comprise determining, by the computing system, based on the plurality of images and the plurality of skeletal segments, a plurality of medial volumes corresponding to the plurality of skeletal segments. The computer-implemented method can comprise generating, by the computing system, a hierarchical skeleton of the avatar based on the plurality of skeletal segments and the plurality of medial volumes.

Another example aspect of the present disclosure is directed to one or more tangible non-transitory computer-readable media storing computer-readable instructions that when executed by one or more processors cause the one or more processors to perform operations. The operations can comprise receiving a plurality of images of an avatar from a plurality of perspectives. The operations can comprise generating, based on inputting the plurality of images into one or more machine-learning models, a plurality of skeletal segments corresponding to the avatar. The operations can comprise determining, based on the plurality of images and the plurality of skeletal segments, a plurality of medial volumes corresponding to the plurality of skeletal segments. The operations can comprise generating a hierarchical skeleton of the avatar based on the plurality of skeletal segments and the plurality of medial volumes.

Another example aspect of the present disclosure is directed to a computing system including: one or more processors; and one or more non-transitory computer-readable media storing instructions that when executed by the one or more processors cause the one or more processors to perform operations. The operations can comprise receiving a plurality of images of an avatar from a plurality of perspectives. The operations can comprise generating, based on inputting the plurality of images into one or more machine-learning models, a plurality of skeletal segments corresponding to the avatar. The operations can comprise determining, based on the plurality of images and the plurality of skeletal segments, a plurality of medial volumes corresponding to the plurality of skeletal segments. The operations can comprise generating a hierarchical skeleton of the avatar based on the plurality of skeletal segments and the plurality of medial volumes.

One example aspect of the present disclosure is directed to a computer-implemented method of generating wearable assets for avatars. The computer-implemented method can comprise receiving, by a computing system comprising one or more processors, a wearable asset associated with an avatar. The computer-implemented method can comprise receiving, by the computing system, a mesh model of the avatar. The mesh model of the avatar can be associated with a hierarchical skeleton comprising a plurality of skeletal segments and a plurality of medial volumes. The computer-implemented method can comprise determining, by the computing system, a plurality of skin deformations of the mesh model at a plurality of positions of the plurality of skeletal segments. The computer-implemented method can comprise generating, by the computing system, based on the plurality of skin deformations of the mesh model of the avatar, a deformable mesh model of the wearable asset.

Another example aspect of the present disclosure is directed to one or more tangible non-transitory computer-readable media storing computer-readable instructions that when executed by one or more processors cause the one or more processors to perform operations. The operations can comprise receiving a wearable asset associated with an avatar. The operations can comprise receiving a mesh model of the avatar. The mesh model of the avatar can be associated with a hierarchical skeleton comprising a plurality of skeletal segments and a plurality of medial volumes. The operations can comprise determining a plurality of skin deformations of the mesh model at a plurality of positions of the plurality of skeletal segments. The operations can comprise generating, based on the plurality of skin deformations of the mesh model of the avatar, a deformable mesh model of the wearable asset.

Another example aspect of the present disclosure is directed to a computing system including: one or more processors; and one or more non-transitory computer-readable media storing instructions that when executed by the one or more processors cause the one or more processors to perform operations. The operations can comprise receiving a wearable asset associated with an avatar. The operations can comprise receiving a mesh model of the avatar. The mesh model of the avatar can be associated with a hierarchical skeleton comprising a plurality of skeletal segments and a plurality of medial volumes. The operations can comprise determining a plurality of skin deformations of the mesh model at a plurality of positions of the plurality of skeletal segments. The operations can comprise generating, based on the plurality of skin deformations of the mesh model of the avatar, a deformable mesh model of the wearable asset.

One example aspect of the present disclosure is directed to a computer-implemented method of generating facial expressions of avatars. The computer-implemented method can comprise receiving, by a computing system comprising one or more processors, avatar data comprising a mesh model associated with an avatar. The mesh model can comprise a plurality of landmark points. The computer-implemented method can comprise determining, by the computing system, the plurality of landmark points that correspond to a facial region of the mesh model. The computer-implemented method can comprise generating, by the computing system, based on inputting the plurality of landmark points that correspond to the facial region into one or more machine-learning models, a plurality of semantic segments corresponding to a plurality of facial features. The computer-implemented method can comprise generating, by the computing system, a plurality of facial expressions based on the plurality of facial features. The plurality of facial expressions can comprise a plurality of configurations of the plurality of facial features.

Another example aspect of the present disclosure is directed to one or more tangible non-transitory computer-readable media storing computer-readable instructions that when executed by one or more processors cause the one or more processors to perform operations. The operations can comprise receiving avatar data comprising a mesh model associated with an avatar. The mesh model can comprise a plurality of landmark points. The operations can comprise determining the plurality of landmark points that correspond to a facial region of the mesh model. The operations can comprise generating, based on inputting the plurality of landmark points that correspond to the facial region into one or more machine-learning models, a plurality of semantic segments corresponding to a plurality of facial features. The operations can comprise generating a plurality of facial expressions based on the plurality of facial features. The plurality of facial expressions can comprise a plurality of configurations of the plurality of facial features.

Another example aspect of the present disclosure is directed to a computing system including: one or more processors; and one or more non-transitory computer-readable media storing instructions that when executed by the one or more processors cause the one or more processors to perform operations. The operations can comprise receiving avatar data comprising a mesh model associated with an avatar. The mesh model can comprise a plurality of landmark points. The operations can comprise determining the plurality of landmark points that correspond to a facial region of the mesh model. The operations can comprise generating, based on inputting the plurality of landmark points that correspond to the facial region into one or more machine-learning models, a plurality of semantic segments corresponding to a plurality of facial features. The operations can comprise generating a plurality of facial expressions based on the plurality of facial features. The plurality of facial expressions can comprise a plurality of configurations of the plurality of facial features. One example aspect of the present disclosure is directed to a computer-

implemented method of processing avatars. The computer-implemented method can comprise receiving, by a computing system comprising one or more processors, avatar data comprising a mesh model associated with an avatar, one or more textures associated with the avatar, and a hierarchical skeleton associated with the avatar. The computer-implemented method can comprise determining, by the computing system, based on one or more criteria associated with a virtual environment, a compatibility of the avatar with the virtual environment. The computer-implemented method can comprise based on the avatar not satisfying the one or more criteria, generating, by the computing system, based on the avatar data, a compatible avatar that is compatible with the virtual environment. The computer-implemented method can comprise sending, by the computing system, the compatible avatar to a remote computing system that is configured to implement the virtual environment.

Another example aspect of the present disclosure is directed to one or more tangible non-transitory computer-readable media storing computer-readable instructions that when executed by one or more processors cause the one or more processors to perform operations. The operations can comprise receiving avatar data comprising a mesh model associated with an avatar, one or more textures associated with the avatar, and a hierarchical skeleton associated with the avatar. The operations can comprise determining, based on one or more criteria associated with a virtual environment, a compatibility of the avatar with the virtual environment. The operations can comprise based on the avatar not satisfying the one or more criteria, generating, based on the avatar data, a compatible avatar that is compatible with the virtual environment. The operations can comprise sending the compatible avatar to a remote computing system that is configured to implement the virtual environment.

Another example aspect of the present disclosure is directed to a computing system including: one or more processors; and one or more non-transitory computer-readable media storing instructions that when executed by the one or more processors cause the one or more processors to perform operations. The operations can comprise receiving avatar data comprising a mesh model associated with an avatar, one or more textures associated with the avatar, and a hierarchical skeleton associated with the avatar. The operations can comprise determining, based on one or more criteria associated with a virtual environment, a compatibility of the avatar with the virtual environment. The operations can comprise based on the avatar not satisfying the one or more criteria, generating, based on the avatar data, a compatible avatar that is compatible with the virtual environment. The operations can comprise sending the compatible avatar to a remote computing system that is configured to implement the virtual environment.

One example aspect of the present disclosure is directed to a computer-implemented method of processing avatar content. The computer-implemented method can comprise receiving, by a computing system comprising one or more processors, from a remote computing system configured to implement a virtual environment, a request for granular content comprising one or more assets associated with an avatar comprising one or more traits. The computer-implemented method can comprise determining, by the computing system, based on the request, one or more application programming interface (API) calls associated with the one or more assets and the one or more traits of the avatar. The computer-implemented method can comprise accessing, by the computing system, the one or more assets associated with the one or more API calls. The computer-implemented method can comprise, based on the remote computing system being authorized to receive the one or more assets, sending, by the computing system, the one or more assets to the remote computing system.

Another example aspect of the present disclosure is directed to one or more tangible non-transitory computer-readable media storing computer-readable instructions that when executed by one or more processors cause the one or more processors to perform operations. The operations can comprise receiving, from a remote computing system configured to implement a virtual environment, a request for granular content comprising one or more assets associated with an avatar comprising one or more traits. The operations can comprise determining, based on the request, one or more application programming interface (API) calls associated with the one or more assets and the one or more traits of the avatar. The operations can comprise accessing the one or more assets associated with the one or more API calls. The operations can comprise, based on the remote computing system being authorized to receive the one or more assets, sending the one or more assets to the remote computing system.

Another example aspect of the present disclosure is directed to a computing system including: one or more processors; and one or more non-transitory computer-readable media storing instructions that when executed by the one or more processors cause the one or more processors to perform operations. The operations can comprise receiving, from a remote computing system configured to implement a virtual environment, a request for granular content comprising one or more assets associated with an avatar comprising one or more traits. The operations can comprise determining, based on the request, one or more application programming interface (API) calls associated with the one or more assets and the one or more traits of the avatar. The operations can comprise accessing the one or more assets associated with the one or more API calls. The operations can comprise, based on the remote computing system being authorized to receive the one or more assets, sending the one or more assets to the remote computing system.

Other aspects of the present disclosure are directed to various systems, apparatuses, non-transitory computer-readable media, user interfaces, and electronic devices. These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, can explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a diagram of an example system according to example embodiments of the present disclosure;

FIG. 2 depicts a diagram of an example computing device according to example embodiments of the present disclosure;

FIG. 3 depicts a diagram of an example machine-learning model according to example embodiments of the present disclosure;

FIG. 4 depicts an example of processing granular content associated with an avatar according to example embodiments of the present disclosure;

FIG. 5 depicts an example of hierarchical skeleton and medial volumes of an avatar according to example embodiments of the present disclosure;

FIG. 6 depicts an example of deforming the skin of a mesh model according to example embodiments of the present disclosure;

FIG. 7 depicts an example of generating facial expressions of an avatar according to example embodiments of the present disclosure;

FIG. 8 depicts a flow diagram of an example method generating optimized semantic segments according to example embodiments of the present disclosure;

FIG. 9 depicts a flow diagram of an example method for generating a hierarchical skeleton of an avatar according to example embodiments of the present disclosure;

FIG. 10 depicts a flow diagram of an example method for generating a deformable mesh model of a wearable asset according to example embodiments of the present disclosure;

FIG. 11 depicts a flow diagram of an example method for generating facial expressions of an avatar according to example embodiments of the present disclosure;

FIG. 12 depicts a flow diagram of an example method for generating compatible avatars for implementation within a virtual environment according to example embodiments of the present disclosure; and

FIG. 13 depicts a flow diagram of an example method for processing granular assets associated with an avatar according to example embodiments of the present disclosure.

Reference numerals that are repeated across plural figures are intended to identify the same features in various implementations.

### DETAILED DESCRIPTION

Generally, the present disclosure is directed to the processing and generation of avatars and associated assets for implementation in a virtual environment. In particular, the disclosed technology is directed to a computing system that can generate optimized semantic segments based on the detection of errors in semantic segments associated with the assets. Further, the disclosed technology can generate hierarchical skeletons, deformable mesh models, and facial expressions on avatars. Additionally, the compatibility of avatars with respect to a virtual environment can be determined and compatible avatars and/or granular content comprising assets associated with avatars can be sent to remote computing systems that are configured to implement the avatars and/or the granular assets.

The disclosed technology can receive a plurality of assets associated with a plurality of avatars. For example, a computing system of the disclosed technology can receive assets comprising virtual garments for use in a virtual environment (e.g., an online multi-player game). The plurality of assets can comprise a plurality of meshes and a plurality of textures. Based on inputting the plurality of assets into one or more machine-learning models, a plurality of semantic segments of the plurality of assets be determined. For example, if the plurality of meshes and the plurality of textures are associated with avatars for an online game, the plurality of assets can comprise costumes and/or accessories for the avatars. Further, based on the plurality of meshes and the plurality of textures, one or more segment errors in the plurality of semantic segments can be detected. For example, semantic segments that are too large and thereby can use excessive amounts of memory and/or computer processing resources can be detected. Based on the one or more segment errors and the plurality of semantic segments, a plurality of optimized semantic segments can be generated. For example, the computing system can generate optimized semantic segments with lower resolution textures and/or simpler mesh meshes.

Additionally, the disclosed technology can receive a plurality of images of an avatar from a plurality of perspectives. For example, the plurality of images can comprise photographic images and/or images of a fictional character that may be used as an avatar. Based on inputting the plurality of images into one or more machine-learning models, a plurality of skeletal segments corresponding to the avatar. The plurality of skeletal segments can, for example, be used when animating an avatar. Based on the plurality of images and the plurality of skeletal segments, a plurality of medial volumes corresponding to the plurality of skeletal segments can be determined. The plurality of medial volumes can be used to enhance the appearance of an avatar by adding volume to the underlying skeletal segments. A hierarchical skeleton of the avatar can then be generated based on the plurality of skeletal segments and the plurality of medial volumes.

Further, the disclosed technology can receive a wearable asset (e.g., a jacket for an avatar) associated with an avatar. A mesh model of the avatar that is associated with a hierarchical skeleton comprising a plurality of skeletal segments and a plurality of medial volumes can also be received. A computing system can then determine a plurality of skin (e.g., the skin comprising the surface of the wearable asset) deformations (e.g., the bunching or stretching of the skin) of the mesh model at a plurality of positions of the plurality of skeletal segments. Based on the plurality of skin deformations of the mesh model of the avatar, a deformable mesh model of the wearable asset can be generated. For example, the The disclosed technology can receive avatar data comprising a mesh model associated with an avatar. The mesh model can comprise a plurality of landmark points that indicate the dimensions of a three-dimensional avatar that can be used in a virtual environment. The plurality of landmark points that correspond to a facial region of the mesh model can be determined. For example, one or more object recognition algorithms can be implemented to detect a facial region of an avatar. Based on inputting the plurality of landmark points that correspond to the facial region into one or more machine-learning models, a plurality of semantic segments corresponding to a plurality of facial features. The plurality of semantic segments can correspond to facial features such as the virtual eyes, virtual nose, and/or virtual mouth of an avatar. Based on the plurality of semantic segments, the computing system can generate a plurality of facial expressions that can comprise a plurality of configurations of the plurality of facial features. For example, the computing system can generate a plurality of expressions comprising smiling, laughing, or surprised expressions that can be used for an avatar.

Further, the disclosed technology can receive avatar data comprising a mesh model associated with an avatar, one or more textures associated with the avatar, and/or a hierarchical skeleton associated with the avatar. Based on one or more criteria associated with a virtual environment, a compatibility of the avatar with the virtual environment. For example, the mesh (e.g., mesh size) and/or textures (e.g., texture resolution) of the avatar can be determined in order to determine if the mesh and texture can operate within a particular virtual environment that is associated with the one or more criteria. Based on the avatar not satisfying the one or more criteria, a compatible avatar that is compatible with the virtual environment can be generated. The compatible avatar may have a smaller file size, have a less complex mesh model, and/or textures. The compatible avatar can then be sent to a remote computing system that is configured to implement the virtual environment.

Additionally, the disclosed technology can receive, from a remote computing system configured to implement a virtual environment, a request for granular content comprising one or more assets (e.g., wearable assets) associated with an avatar comprising one or more traits. Based on the request, one or more application programming interface (API) calls associated with the one or more assets and the one or more traits of the avatar can be determined. For example, the one or more traits of the avatar can indicate an age or preferences of a user and can be used to determine the one or more assets that can be sent. The one or more assets associated with the one or more API calls can then be accessed and sent to the remote computing system that sent the request for the granular content.

The disclosed technology can automatically generate and/or process avatars for more effective implementation in virtual environments. Further, the disclosed technology can use one or more machine-learning models to generate, process, and/or modify avatars and/or assets associated with avatars. Accordingly, the disclosed technology can improve the user experience by automatically generating avatars.

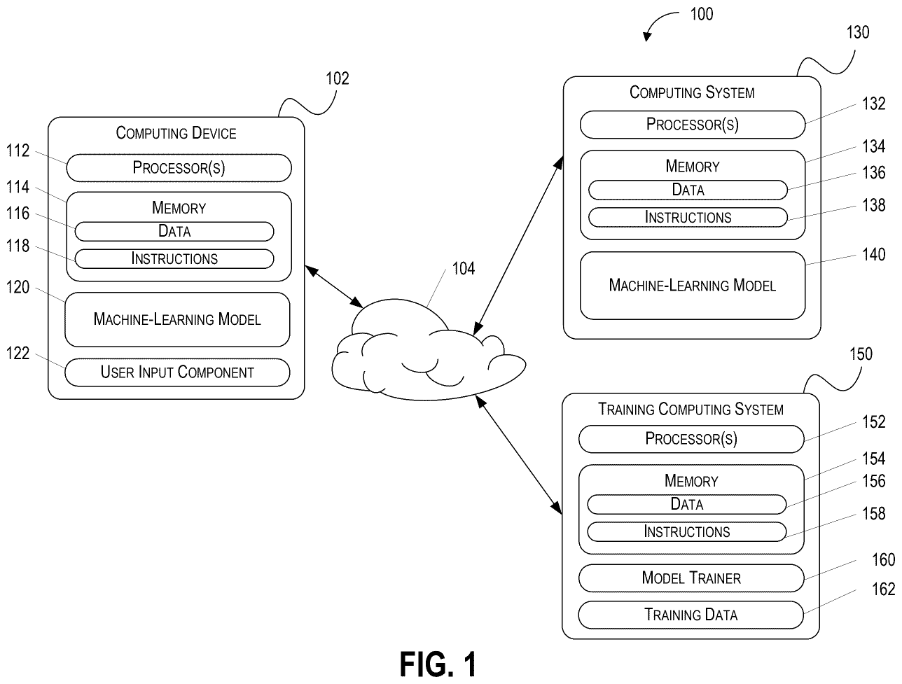

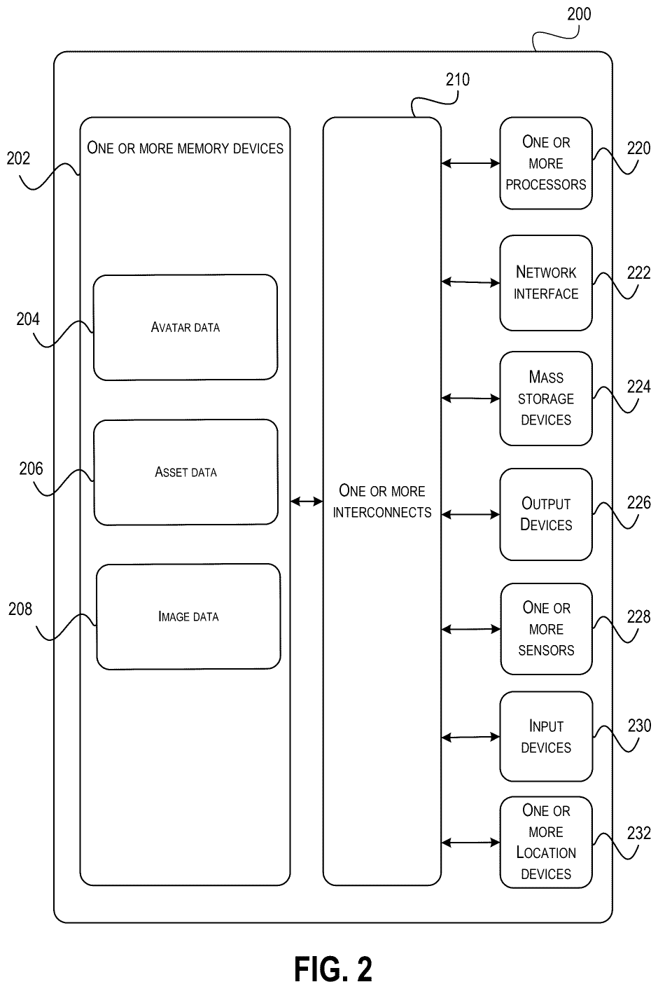

In some embodiments, the disclosed technology can comprise a computing system (e.g., a virtual environment computing system) that can comprise one or more computing devices (e.g., devices with one or more computer processors and a memory that can store one or more instructions) that can send, receive, process, generate, and/or modify data (e.g., data associated with one or more avatars (e.g., mesh models and/or textures associated with an avatar), assets (e.g., mesh models and/or textures associated with an asset) associated with an avatar, and/or a virtual environment). The data and/or one or more signals can be communicated (e.g., sent and/or received) by the computing system to and/or from other systems and/or devices (e.g., one or more remote computing systems, one or more remote computing devices, and/or one or more software applications operating on one or more computing devices) that can be configured to send and/or receive data that indicates the state of an avatar, assets associated with an avatar, and/or a virtual environment. In some embodiments, the computing system (e.g., the virtual environment computing system) can comprise one or more features of the device 102 that is described with respect to FIG. 1 and/or the computing device 200 that is described with respect to FIG. 2. Further, the virtual environment computing system can be associated with one or more machine-learning models that can include one or more features of the one or more machine-learning models 120 that are described with respect to FIG. 1.

Furthermore, the computing system can comprise specialized hardware (e.g., an application specific integrated circuit) and/or software that enables the computing system to perform one or more operations specific to the disclosed technology including generating optimized semantic segments based on assets comprising meshes and textures associated with avatars; generating hierarchical skeletons, mesh models of wearable assets, and/or facial expressions associated with mesh models of avatars; determining the compatibility of avatars with a virtual environment; and/or sending compatible avatars and granular assets associated with avatars to remote computing systems that are configured to implement the avatars within a virtual environment.

The computing system can be configured to generate optimized semantic segments based on the detection of segment errors in semantic segments associated with assets (e.g., assets associated with an avatar). The computing system can receive a plurality of assets associated with a plurality of avatars. Further, the plurality of assets can comprise a plurality of meshes and a plurality of textures. For example, the computing system can receive a plurality of assets comprising three-dimensional mesh models of the clothing of avatars and the textures associated with the mesh models of the clothing that can be implemented in a virtual environment (e.g., three-dimensional models of characters in a virtual environment).

The computing system can be configured to generate, modify, and/or process avatars and/or assets associated with avatars. An avatar can comprise a representation (e.g., visual representation) of a figure (e.g., a human shaped figure) that can comprise a mesh model that can be deformable and comprise a surface associated with textures. Further, the avatar can be associated with a hierarchical skeleton that comprises a plurality of segments that can correspond to the mesh model of the avatar.

Further, the computing system can implement an avatar in a virtual environment. The virtual environment can comprise a representation (e.g., a three-dimensional representation of an actual environment or synthetic environment). The virtual environment can comprise a synthetic environment (e.g., a three-dimensional environment that can be rendered on a display device) and/or real-world environment (e.g., the real-world surroundings of a user that can be detected by sensors and rendered on a display device). By way of example, a virtual environment can comprise a virtual meeting place (e.g., a virtual conference room), a virtual educational place (e.g., a virtual class room or a virtual lecture hall), a virtual auditorium (e.g., a virtual concert hall), a virtual race course (e.g., a virtual auto racing track, foot racing track, or rowing course), a virtual fantasy environment (e.g., a virtual environment based on a fantasy book or science-fiction movie), and/or a virtual representation of a real-world location (e.g., the Louvre in Paris or Lake Baikal in Russia).

The disclosed technology can be implemented by a computing system that can determine a plurality of semantic segments of the plurality of assets. Determination of the plurality of semantic segments can be based on inputting the plurality of assets into one or more machine-learning models. The one or more machine-learning models can be configured to process and/or evaluate the plurality of assets and generate output comprising a plurality of semantic segments of the plurality of assets. Further, the one or more machine-learning models can be configured to perform one or more object analysis and recognition operations in which the shape of the plurality of meshes and the colors and/or patterns of the plurality of textures can be determined. For example, a plurality of semantic segments corresponding to the virtual wheels, virtual chassis, virtual windows, and virtual doors of a virtual vehicle asset can be determined based on output from the one or more machine-learning models that are configured and/or trained to generate the plurality of semantic segments based on inputting the virtual vehicle asset into the one or more machine-learning models.

In some embodiments, the plurality of semantic segments can comprise one or more facial segments and/or one or more body segments that can be different from the one or more facial segments. For example, the one or more facial segments can comprise virtual glasses, virtual hats, virtual necklaces, and/or virtual earrings that can be associated with a facial region of an avatar. Further, the one or more body segments can be associated with virtual shirts, virtual trousers, virtual shoes, virtual jackets, virtual dresses, virtual blouses, virtual skirts, and/or virtual shorts that can be associated with the avatar.

The computing system can detect, based on the plurality of meshes and the plurality of textures, one or more segment errors in the plurality of semantic segments. Further, the computing system can detect semantic segments that comprise one or more features that cause the semantic segment to be incompatible with an avatar. For example, a semantic segment corresponding to a virtual hat for an avatar may have a texture that is transparent, which would render the virtual hat invisible, which could be determined to comprise one or more segment errors if the virtual hat was supposed to be visible. By way of further example, a semantic segment corresponding to a virtual sleeping bag may be determined to comprise one or more segment errors if the virtual sleeping bag is not able to accommodate an avatar.

The computing system can generate, based on the one or more segment errors and the plurality of semantic segments, a plurality of optimized semantic segments. Further, the computing system can determine one or more types of segment errors and generate an optimized semantic segment based on the type of segment error. For example, a segment error in which a color of a texture is erroneous (e.g., a semantic segment that should be opaque is transparent) may cause the computing system to modify the color of the semantic segment so that the semantic segment is opaque. By way of further example, a segment error in which the shape of a mesh is erroneous (e.g., a semantic segment that should be flat is curved) may cause the computing system to modify the shape of the semantic segment so that the semantic segment is flat.

In some embodiments, the one or more segment errors can comprise a resolution of the plurality of textures not satisfying one or more resolution criteria. The one or more resolution criteria can comprise a resolution of a semantic segment exceeding a size threshold (e.g., the resolution is too large). In some embodiments, the generating, based on the one or more segment errors and the plurality of semantic segments, a plurality of optimized semantic segments can comprise modifying one or more resolutions of the plurality of textures to satisfy the one or more resolution criteria. Further, the computing system can reduce the resolution of a texture that is determined to be too large and increase the resolution of a texture that is determined to be too small. For example, the computing system can resize a texture by implementing an image scaling algorithm (e.g., nearest neighbor interpolation or Fourier based interpolation).

In some embodiments, the one or more segment errors can comprise a mesh size of the plurality of meshes not satisfying one or more mesh size criteria. The one or more mesh size criteria can comprise the size of a mesh associated with a semantic segment exceeding a size threshold (e.g., the mesh is too large). In some embodiments, the generating, based on the one or more segment errors and the plurality of semantic segments, a plurality of optimized semantic segments can comprise modifying, one or more mesh sizes of the plurality of meshes to satisfy one or more mesh size criteria. For example, the computing system can increase the size of a mesh that is determined to be too small and decrease the size of a mesh that is determined to be too large.

The computing system can be configured to generate hierarchical skeletons based on images of an avatar. The computing system can receive a plurality of images of an avatar from a plurality of perspectives. The plurality of images can comprise two-dimensional images and/or three-dimensional images of an avatar. Further, the plurality of perspectives can comprise perspectives that capture various sides of the avatar (e.g., a front perspective, rear perspective, side perspective, and/or top-down perspective). The plurality of images of the avatar can comprise information associated with the color of various portions of the avatar (e.g., RGB information). For example, the computing system can receive the plurality of images from a remote computing device that stores images of art depicting figures (e.g., human figures) that can be used as the visual basis for an avatar.

The computing system can generate a plurality of skeletal segments corresponding to the avatar. Generation of the plurality of skeletal segments corresponding to the avatar can be based on inputting the plurality of images into one or more machine-learning models, a plurality of skeletal segments corresponding to the avatar. The one or more machine-learning models can be configured to process and/or evaluate the plurality of images and generate output comprising a plurality of skeletal segments of the plurality of images. The one or more machine-learning models can be configured to perform one or more image analysis and recognition operations in which one or more features of an image (e.g., the shape, color, and/or spatial relationships of portions of an image) and the plurality of skeletal segments can be determined. For example, a plurality of skeletal segments corresponding to the arms, legs, torso, head, and neck of an avatar can be determined based on output from the one or more machine-learning models that are configured and/or trained to generate the plurality of skeletal segments based on inputting an image into the one or more machine-learning models.

The computing system can determine, based on the plurality of images and the plurality of skeletal segments, a plurality of medial volumes corresponding to the plurality of skeletal segments. For example, the computing system can input the plurality of images into one or more machine-learning models that are configured to generate a plurality of medial volumes corresponding to the plurality of images. The one or more machine-learning models may process and/or evaluate one or more features of the plurality of images and generate medial volumes that correspond to the plurality of images. Further, the one or more machine-learning models can identify the portions of the images that correspond to the plurality of skeletal segments and generate medial volumes that correspond to the portions of the images. For example, if an image depicts rounded forearms, then the medial volume that is generated can be similarly rounded.

In some embodiments, determining, based on the plurality of images and the plurality of skeletal segments, a plurality of medial volumes corresponding to the plurality of skeletal segments can comprise determining a plurality of medial axes corresponding to the plurality of skeletal segments. For example, the computing system can input the plurality of images into one or more machine-learning models that are configured to generate a plurality of medial axes corresponding to the plurality of images. The one or more machine-learning models may process and/or evaluate one or more features of the plurality of images and generate medial axes that correspond to the plurality of skeletal segments. Further, the one or more machine-learning models can use the medial axis of a skeletal segment to generate a medial volume. For example, the computing system can make the medial axis the thickest point of a medial volume.

In some embodiments, determining, based on the plurality of images and the plurality of skeletal segments, a plurality of medial volumes corresponding to the plurality of skeletal segments can comprise determining a plurality of depth maps corresponding to the plurality of images. For example, the computing system can analyze the plurality of images and generate a depth map (e.g., data indicating the distance from a viewpoint of each point in an image). The computing system can then use the depth map to determine the plurality of medial volumes for each of the plurality of skeletal segments corresponding to the plurality of images.

In some embodiments, determining, based on the plurality of images and the plurality of skeletal segments, a plurality of medial volumes corresponding to the plurality of skeletal segments can comprise generating a plurality of voxels based on the plurality of images and the plurality of skeletal segments. For example, the computing system can use one or more object recognition techniques to recognize objects in the plurality of images and/or estimate the depths of the objects in the image. Further, determining the plurality of medial volumes corresponding to the plurality of skeletal segments can comprise generating the plurality of medial volumes based on application of one or more voxel thinning techniques to the plurality of voxels. For example, the computing system can determine an outer boundary of the plurality of voxels and generate the plurality of skeletal segments based on reducing the plurality of voxels to a single contiguous set of voxels.

The computing system can generate a hierarchical skeleton of the avatar based on the plurality of skeletal segments and the plurality of medial volumes. Further, generating the hierarchical skeleton can be based on determining a skeletal segment class that each of the plurality of skeletal segments belongs to. The computing system can then join each of the plurality of skeletal segments to one or more skeletal segments with which the skeletal segment is associated. For example, a first skeletal segment can be determined to be part of the head class, a second skeletal segment can be determined to be part of the upper leg class, and a third skeletal segment can be determined to be part of the lower leg class. In this example, the second skeletal segment and the third skeletal segment can be joined to one another in a particular orientation (e.g., the lower part of the second skeletal segment can join the upper part of the third skeletal segment) but cannot be joined to the first skeletal segment which can only be joined to a skeletal segment belonging to the neck class.

In some embodiments, the hierarchical skeleton can comprise information associated with one or more ranges of motion of the plurality of skeletal segments corresponding to the avatar. For example, each of the plurality of skeletal segments in the hierarchical skeleton can be constrained by the one or more ranges of motion. The one or more ranges of motion can, for example, limit the range of motion of the virtual arms and virtual legs of the avatar so that the range of motion and/or movements of an avatar can be similar to the range of motion and/or movements of an actual human being.

A computing system can be configured to generate wearable assets for avatars based on receiving a mesh model of the avatar. In particular, the computing system can receive a wearable asset. The wearable asset can be associated with an avatar. The plurality of wearable assets can comprise a plurality of meshes and/or plurality of textures associated with the wearable assets. For example, the plurality of wearable assets can comprise virtual clothing (e.g., a virtual hat, virtual scarf, virtual shirt, virtual gloves, virtual coat, virtual sweater, virtual dress, virtual blouse, virtual skirt, virtual trousers, virtual shorts, virtual socks, and/or virtual shoes), virtual accessories (e.g., a virtual wristwatch, virtual jewelry, virtual armband, virtual bracelet, virtual necklace, and/or virtual earrings), and/or virtual bags (e.g., a virtual backpack and/or virtual handbag).

The computing system can receive a mesh model of the avatar. For example, the mesh model of an avatar can comprise a two-dimensional model and/or three-dimensional mesh model of an avatar. The mesh model of the avatar can be associated with a hierarchical skeleton comprising a plurality of skeletal segments and a plurality of medial volumes. Each of the plurality of skeletal segments can be associated with a corresponding medial volume of the plurality of medial volumes. The medial volume can comprise a two-dimensional set of points (e.g., x and y coordinates) or three-dimensional set of points (e.g., x, y, and z coordinates) that correspond to a medial volume. For example, the combination of a skeletal segment and the corresponding medial volume associated with the skeletal segment can form the virtual forearm of an avatar.

The computing system can determine a plurality of skin deformations of the mesh model at a plurality of positions of the plurality of skeletal segments. For example, the computing system can use the size of the medial volume and one or more attributes of the medial volume (e.g., compressibility, stretchiness, and/or firmness) to determine the skin deformation of the mesh model. For example, if attributes of the medial volume are associated with a high level of firmness (e.g., a virtual athletic and firm body) then the skin deformation at the plurality of positions of the plurality of skeletal segments can be low. By way of further example, if attributes of the medial volume are associated with a low level of firmness (e.g., a virtual unfit and soft body) then the skin deformation at the plurality of positions of the plurality of skeletal segments can be high.

In some embodiments, the plurality of positions of the plurality of skeletal segments can be based on one or more range of motion parameters of the hierarchical skeleton. For example, the plurality of positions of the plurality of skeletal segments can be constrained by the one or more range of motion parameters. The one or more range of motion parameters can, for example, limit the range of motion of the virtual neck and virtual head of an avatar to 180 degrees (e.g., the virtual neck and virtual head of an avatar can turn from the direction of the virtual left shoulder of the avatar to the virtual right shoulder of the avatar).

In some embodiments, determining a plurality of skin deformations of the mesh model at a plurality of positions of the plurality of skeletal segments can comprise determining the plurality of skin deformations based on inputting the mesh model of the avatar at the plurality of positions into one or more machine-learning models that can be configured to determine the plurality of skin deformations. The one or more machine-learning models can be configured to process and/or evaluate the mesh model of the avatar at a plurality of positions of the plurality of skeletal segments and generate output comprising a plurality of skin deformations of the mesh model at the plurality of positions of the plurality of skeletal segments. The one or more machine-learning models can be configured to perform one or more deformation prediction operations in which the shape of the mesh model at the plurality of positions can be determined. For example, the plurality of skin deformations of the mesh model can be determine that bending a virtual leg of an avatar can deform the upper portion of the virtual leg of the avatar (e.g., the portion of the leg of the avatar that is between the virtual torso and virtual knee of the avatar).

The computing system can generate, based on the plurality of skin deformations of the mesh model of the avatar, a deformable mesh model of the wearable asset. For example, the deformable mesh model of the wearable asset can be generated based on modifying the wearable asset such that the wearable asset will conform to the deformations of the mesh model of the avatar. Further, based on the type of material associated with the wearable asset, the deformations of the deformable mesh model can be based on the deformation of the mesh model of the avatar. For example, a deformable mesh model of a virtual suit of steel armor may have no deformation when the mesh model of the avatar deforms and may deform when some other virtual object (e.g., a virtual sword) impacts the virtual suit of steel armor. By way of further example, a deformable mesh model of a virtual sweater may deform significantly when the mesh model of the avatar deforms and the deformations of the virtual sweater can comprise the sweater bunching up when the arm segments of the mesh model of the avatar are bent and/or the sweater stretching when pulled.

In some embodiments, generating, based on the plurality of skin deformations of the mesh model of the avatar, a deformable mesh model of the wearable asset can comprise generating, the mesh model of the avatar based on inputting the wearable asset and the plurality of skin deformations of the avatar into one or more machine-learning models that can be configured to generate the deformable mesh model of the wearable asset. The one or more machine-learning models can be configured to process and/or evaluate the mesh model of the avatar at a plurality of positions of the plurality of skeletal segments and generate output comprising a plurality of skin deformations of the mesh model at the plurality of positions of the plurality of skeletal segments. The one or more machine-learning models can be configured to perform one or more deformation prediction operations in which the shape of the mesh model at the plurality of positions can be determined. For example, the plurality of skin deformations of the mesh model can be determine that bending a virtual leg of an avatar can deform the upper portion of the virtual leg of the avatar (e.g., the portion of the virtual leg of the avatar that is between the virtual torso and virtual knee of the avatar).

A computing system can be configured to generate facial expressions of avatars based on avatar data comprising a mesh model of an avatar. In particular, the computing system can receive avatar data comprising a mesh model that can be associated with an avatar. The mesh model can comprise a plurality of landmark points that can correspond to a two-dimensional surface or a three-dimensional surface of an avatar.

In some embodiments, the plurality of landmark points can be based on one or more real-world facial features detected by one or more sensors. For example, the plurality of landmark points can be based on sensor data generated by one or more sensors comprising one or more cameras, one or more infrared detection devices, one or more LiDAR devices, one or more sonar devices, and/or one or more microphones) that are configured to detect facial features (e.g., the facial features of a user).

The computing system can determine the plurality of landmark points that correspond to a facial region of the mesh model. Further, the computing system can determine the facial region of the mesh model based on the use of one or more criteria associated with the distribution of landmark points. For example, the one or more criteria can comprise one or more location criteria that can be satisfied by a threshold number of landmark points being located within a facial region (e.g., the front of the head of an avatar). Further, the one or more criteria can comprise one or more shape criteria. The computing system can perform object recognition operations to recognize shapes that are formed by groupings of the plurality of landmark points. For example, a protrusion satisfies one or more shape criteria can be determined to be a virtual nose of an avatar. The computing system can then determine the facial region based on the location of the virtual nose (e.g., the facial region can comprise a region surrounding the virtual nose).

The computing system can generate a plurality of semantic segments corresponding to a plurality of facial features. The facial features can comprise portions of a face (e.g., nose, eyes, mouth, chin, forehead, and/or cheeks). Generation of the plurality of semantic segments corresponding to a plurality of facial features can be based on inputting the plurality of landmark points that correspond to the facial region into one or more machine-learning models. The one or more machine-learning models can be configured to process and/or evaluate the plurality of landmark points and generate output comprising semantic segments corresponding to a plurality of facial features. The one or more machine-learning models can be configured to perform one or more facial recognition operations in which one or more portions of the plurality of semantic segments can be recognized as facial features based on the shape, size, and/or location of different combinations of the plurality of landmark points. For example, the facial region of the mesh model may be located at a distal end of a mesh model and may comprise landmark points that are located on a shape that is similar to a head (e.g., an ellipsoid that has protrusions in locations that could correspond to a nose and/or ears).

The computing system can generate a plurality of facial expressions based on the plurality of facial features. Further, the plurality of facial expressions can comprise a plurality of configurations of the plurality of facial features. For example, the plurality of facial features can comprise a virtual mouth which can be configured to indicate various facial expressions. For example, a tightly closed virtual mouth can indicate an upset expression, a slightly wide-open mouth in an “O” shape can indicate a surprised expression, and a very wide-open mouth can indicate a yawn or bored expression.

In some embodiments, the plurality of configurations of the plurality of facial features can comprise a plurality of different spatial relationships of the plurality of facial features. For example, the plurality of facial features can include virtual eyebrows and virtual eyes. The spatial relationship between the virtual eyebrows and the virtual eyes can change by raising the virtual eyebrows to be a greater distance from the virtual eyes.

In some embodiments, generating the plurality of facial expressions based on the plurality of facial features can comprise modifying, a plurality of spatial relationships of the plurality of facial features. For example, to generate a facial expression comprising a smile the computing system can adjust the plurality of spatial relationships of the plurality of facial features associated with the virtual mouth of an avatar such that the edges of the virtual mouth turn up in an expression that can be similar to an actual smile.

A computing system can be configured to generate compatible avatars that can be sent to remote computing systems that can be configured to implement the avatar. In particular, the computing system can receive avatar data comprising a mesh model associated with an avatar, one or more textures associated with the avatar, and/or a hierarchical skeleton associated with the avatar. For example, the computing device can receive avatar data from another computing system (e.g., a user's computing system) that was used to generate an avatar.

The computing system can determine, based on one or more criteria associated with a virtual environment, a compatibility of the avatar with the virtual environment. The computing system can evaluate the one or more criteria to determine whether an avatar is compatible with a virtual environment. The determining whether the one or more criteria are satisfied can comprise determining whether an avatar is able to be used in a virtual environment.

In some embodiments, the one or more criteria can comprise a mesh format of the mesh model matching a mesh format of the virtual environment. For example, different virtual environments can use different mesh formats (e.g., polygonal mesh formats comprising vertices, edges, and faces) that may not be interoperable and may not be compatible with avatars configured to operate within other virtual environments. Further, generating, based on the avatar data, a compatible avatar that is compatible with the virtual environment can comprise modifying, the mesh format of the mesh model to match the mesh format of the virtual environment.

In some embodiments, the one or more criteria can comprise a texture format of the one or more textures matching a texture format of the virtual environment. Further, generating, based on the avatar data, a compatible avatar that is compatible with the virtual environment can comprise modifying, the texture format of the one or more textures to match the texture format of the virtual environment. For example, different virtual environments can use different texture formats (e.g., the resolution and/or color space associated with a texture format) that may not be interoperable and may not be compatible with avatars configured to operate within other virtual environments.

Further, generating, based on the avatar data, a compatible avatar that is compatible with the virtual environment can comprise modifying, the texture format of the texture model to match the texture format of the virtual environment. If the avatar satisfies the one or more criteria and is compatible with a virtual environment, the avatar may be sent to a remote computing system that can implement the avatar in the virtual environment associated with the remote computing system.

The computing system can, based on the avatar not satisfying the one or more criteria, generate, based on the avatar data, a compatible avatar that is compatible with the virtual environment. For example, the computing system can reduce the resolution of a texture format that is not compatible due to the resolution of the texture exceeding a texture resolution of a virtual environment. By way of further example, the computing system can perform one or more smoothing operations to reduce the polygon count of a mesh that is not compatible due to the polygon count of the mesh exceeding a polygon count threshold of a virtual environment.

In some embodiments, generating, based on the avatar data, a compatible avatar that is compatible with the virtual environment can comprise modifying, the hierarchical skeleton associated with the avatar. For example, a virtual environment may require that a hierarchical skeleton does not comprise more than a threshold number of skeletal segments. The computing system can merge and/or remove one or more skeletal segments to satisfy the threshold number of skeletal segments of the virtual environment. For example, the computing system can merge a virtual hand with a virtual forearm to reduce the number of skeletal segments. Further, the computing system can remove one or more virtual toes to reduce the number of skeletal segments. The merging and/or removal of skeletal segments can be prioritized such that certain skeletal segments can be removed before other skeletal segments. For example, skeletal segments in virtual limbs (e.g., virtual arms and/or virtual legs) can be higher priority relative to virtual forelimbs (e.g., virtual fingers and/or virtual toes) that can be lower priority and merged or removed before the virtual limbs.

The computing system can send the compatible avatar to a remote computing system that is configured to implement the virtual environment. For example, the computing system can send the compatible avatar to the remote computing system via the Internet. The compatible avatar can comprise information (e.g., the mesh format, texture format, texture resolution, and/or polygon count) that indicates the compatibility of the avatar with the virtual environment implemented by the remote computing system.

A computing system can be configured to access granular assets based on determined API calls and then send the granular assets to a remote computing system. In particular, the computing system can receive a request (e.g., an API request) for granular content. The request can be received from a remote computing system configured to implement a virtual environment. Further, the granular content can comprise one or more assets associated with an avatar comprising one or more traits. Further, the granular content can comprise one or more assets and/or portions of assets (e.g., mesh and/or texture of an asset). The one or more traits can comprise visual traits (e.g., traits associated with the visual features of an avatar), kinetic traits (e.g., traits associated with the movement speed of an avatar), aural traits (e.g., traits associated with the sounds an avatar can generate), and/or communication traits (e.g., traits associated with the way communication by the avatar is performed).

In some embodiments, the granular content can comprise one or more textures that can be configured to overlay a mesh model of the avatar. For example, granular content comprising the texture of a first asset (e.g., a blue denim jean texture) can be used with the mesh of a second different asset (e.g., a mesh of a dress that was associated with a virtual red silk texture).

In some embodiments, the granular content can comprise one or more wearable assets that can be configured to overlay a mesh model of the avatar. For example, the granular content can comprise wearable clothing assets (e.g., virtual hats, virtual gloves, virtual shirts, virtual trousers, virtual dresses, and/or virtual shoes) that can be associated with an avatar and can overlay the mesh model of the avatar.

The computing system can determine, based on the request, one or more application programming interface (API) calls associated with the one or more assets and the one or more traits of the avatar. The one or more traits can be used to determine the one or more assets that are available to the remote computing system. The traits can be associated with a class of avatar (e.g., a profession associated with an avatar) and/or a status (e.g., a status of an avatar that allows the avatar to receive certain assets). Further, the computing system can access a lookup table that comprises API calls for a plurality of assets. The computing system can compare the one or more assets to the API calls to determine the API calls that match the one or more assets.

The computing system can access the one or more assets associated with the one or more API calls. Further, the computing system can use the one or more API calls to access one or more assets that are stored locally and/or access one or more assets that are stored at a remote location. For example, the one or more assets can be stored in an asset repository of the computing system which can be configured to retrieve one or more assets based on API calls.

The computing system can send the one or more assets to the remote computing system. For example, the computing system can send the one or more assets to the remote computing system via the Internet. The one or more assets can then be used in a virtual environment that can be implemented by the remote computing system.

In some embodiments, the computing system can send the one or more assets to the remote computing system based on the remote computing system being authorized to receive the one or more assets. For example, the computing system can require an authorization code from the remote computing system before sending the one or more assets to the remote computing system.

The systems, methods, devices, apparatuses, and tangible non-transitory computer-readable media in the disclosed technology can provide a variety of technical effects and benefits including improving the processing, generation, and/or distribution of avatars and associated assets that can be implemented in virtual environments. In particular, the disclosed technology may assist a user (e.g., a user of an application that implements an avatar in a virtual environment) in performing a technical task (e.g., modifying an avatar for more effective use in a virtual environment) by means of a continued and/or guided human-machine interaction process. It may also provide benefits including facilitating communication in a virtual environment, improving the efficiency of modifying avatars in a virtual environment, and/or reducing inefficiencies in communications networks.

The disclosed technology can improve the use of computational resources by optimizing semantic segments of assets. For example, by proactively modifying the size of an asset's mesh to conform to the size of the mesh of an associated avatar, the disclosed technology can reduce the less efficient modification of asset size that may be performed locally. Further, optimized semantic segments may use less storage capacity.

Additionally, use of the disclosed technology can significantly reduce the amount of time that is spent modifying and/or generating an avatar that accurately reflects the preferences of a user. For example, the automatic generation of deformable assets that can be associated with an avatar can reduce the amount of time that a user spends modifying existing assets that meet a user's preferences.

Accordingly, the disclosed technology may improve the effectiveness with which avatars and/or associated assets are processed, generated, and/or transmitted in a virtual environment, thereby allowing a computing device to perform more efficiently/effectively the technical task of implementing avatars and associated assets in a virtual environment by means of a continued and/or guided human-machine interaction process. In addition, the disclosed technology may provide a computing system that facilitates more effective detection of inputs and generation of traits that are used to modify virtual objects in a virtual environment. The disclosed technology provides the specific benefits of improved generation of representations of avatars in virtual environments, which can be used to improve the effectiveness of a wide variety of services including online collaboration services, gaming services, online meeting services, and/or educational services.

With reference now to FIGS. 1-13, example embodiments of the present disclosure will be discussed in further detail. FIG. 1 depicts a diagram of an example system according to example embodiments of the present disclosure. The system 100 can comprise a computing device 102, a server computing system 130, and/or a training computing system 150 that are communicatively connected and/or coupled over a network 104.

The computing device 102 can comprise any type of computing device, including, for example, an extended reality computing device (e.g., a computing device that can be used to implement virtual reality, augmented reality, and/or mixed reality), a personal computing device (e.g., a laptop computing device or a desktop computing device), a mobile computing device (e.g., smartphone or tablet), a gaming console, a controller, a wearable computing device (e.g., a smart watch), an embedded computing device, and/or any other type of computing device.

The computing device 102 can comprise one or more processors 112 and one or more memory devices 114. The one or more processors 112 can comprise any suitable processing device (e.g., a processor core, a microprocessor, an ASIC, a FPGA, a controller, and/or a microcontroller) and can comprise one processor or a plurality of processors that are operatively connected. The one or more memory devices 114 can comprise one or more non-transitory computer-readable storage mediums, including RAM, ROM, EEPROM, EPROM, solid state drives (SSDs), and/or hard disk drives (HDDs). The one or more memory devices 114 can be configured to store the data 116 and/or the instructions 118 which can be executed by the processor 112 to cause the computing device 102 to perform operations.

In some embodiments, the computing device 102 can perform one or more operations including generating optimized semantic segments based on assets comprising meshes and textures associated with avatars; generating hierarchical skeletons, mesh models of wearable assets, and/or facial expressions associated with mesh models of avatars; determining the compatibility of avatars with a virtual environment; and/or sending compatible avatars and granular assets associated with avatars to remote computing systems that are configured to implement the avatars within a virtual environment.

In some implementations, the computing device 102 can store and/or implement include one or more machine-learning models including the one or more machine-learning models 120. For example, the one or more machine-learning models 120 can comprise various machine-learning models based on various types of machine-learning frameworks including neural networks (e.g., deep neural networks), generative adversarial networks, and/or other types of machine-learning frameworks that can comprise non-linear models and/or linear models. Neural networks can comprise feed-forward neural networks, recurrent neural networks (e.g., long short-term memory recurrent neural networks), convolutional neural networks or other forms of neural networks. Examples of the one or more machine-learning models 120 are described herein.

In some implementations, the one or more machine-learning models 120 can be received from the server computing system 130 over network 104, stored in the one or more memory devices 114, and can be used or otherwise implemented by the one or more processors 112. In some implementations, the computing device 102 can implement multiple parallel instances of a single machine-learning model of the one or more machine-learning models 120 (e.g., to perform parallel trait generation operations across multiple instances of the machine-learning model 120). The one or more machine-learning models 120 can generate one or more modifications of mesh models associated with an avatar and/or assets associated with an avatar. More particularly, the one or more machine-learning models 120 can generate semantic segments of assets associated with an avatar, generate skeletal segments corresponding to an avatar, determine skin deformations of an avatar, and/or generate a deformable mesh model of a wearable asset.

Additionally or alternatively, one or more machine-learning models 140 can be included in or otherwise stored and implemented by the server computing system 130 that can communicate with the computing device 102. For example, the machine-learning models 140 can be implemented by the server computing system 130 as a portion of a web service (e.g., a virtual environment service). Thus, one or more machine-learning models 120 can be stored and implemented at the computing device 102 and/or one or more machine-learning models 140 can be stored and implemented by the server computing system 130.

The computing device 102 can also include one or more of the user input components 122 that can be configured to receive one or more user inputs. For example, the one or more user input components 122 can comprise a keyboard, mouse, and/or a touch-sensitive component (e.g., a touch-sensitive display). Other examples of the one or more user input components include a microphone, stylus, a camera configured to capture images of a user (e.g., a user's hands gesturing or a user's head nodding) that can be used as input, and/or other devices a user can use to provide user input.

The server computing system 130 can comprise one or more processors 132 and one or more memory devices 134. The one or more processors 132 can comprise any suitable processing device (e.g., a processor core, a microprocessor, an ASIC, a FPGA, a controller, and/or a microcontroller) and can comprise one processor or a plurality of processors that are operatively connected. The one or more memory devices 134 can comprise one or more non-transitory computer-readable storage mediums, including RAM, ROM, EEPROM, EPROM, solid state drives (SSDs), and/or hard disk drives (HDDs). The one or more memory devices 134 can be configured to store the data 136 and/or instructions 138 which can be executed by the processor 132 to cause the server computing system 130 to perform operations.

In some embodiments, the server computing system 130 can perform one or more operations including generating optimized semantic segments based on assets comprising meshes and textures associated with avatars; generating hierarchical skeletons, mesh models of wearable assets, and/or facial expressions associated with mesh models of avatars; determining the compatibility of avatars with a virtual environment; and/or sending compatible avatars and granular assets associated with avatars to remote computing systems that are configured to implement the avatars within a virtual environment.

Furthermore, the server computing system 130 can perform analysis of data (e.g., avatar data, wearable asset data, and/or granular asset data) that are provided to the server computing system 130. For example, the server computing system 130 can receive data, via the network 104, including data associated with mesh models, textures, hierarchical skeletons, and/or images. The server computing system 130 can then perform various operations, which can comprise the use of the one or more machine-learning models 140, to detect, determine, modify, and/or generate one or more semantic segments of assets, skeletal segments of avatars, skin deformations of avatars, and/or deformable mesh models of wearable assets. By way of further example, the server computing system 130 can detect and/or classify one or more assets associated with an avatar and generate semantic segments based on the detected assets. In another example, the server computing system 130 can send compatible avatars and/or granular assets to one or more remote computing systems (not shown). The data sent by the server computing system 130 can be based on one or more requests from the one or more remote computing systems. Further, a copy of the data sent by the server computing system 130 can be stored (e.g., stored in a virtual environment repository) for later use by the server computing system 130.

In some implementations, the server computing system 130 can comprise and/or can be implemented by one or more server computing devices. In instances in which the server computing system 130 includes multiple server computing devices, such server computing devices can operate according to various architectures which can comprise sequential computing architectures and/or parallel computing architectures.

As described above, the server computing system 130 can store or otherwise implement one or more machine-learning models 140. For example, the one or more machine-learning models 140 can comprise various machine-learning models. Example machine-learning models can comprise neural networks or other multi-layer non-linear models. Example neural networks can comprise feed forward neural networks, deep neural networks, recurrent neural networks, and/or convolutional neural networks. Examples of the one or more machine-learning models 140 are discussed with reference to FIGS. 1-13.

The computing device 102 and/or the server computing system 130 can train the one or more machine-learning models 120 and/or 140 via interaction with the training computing system 150 that can be communicatively connected and/or coupled over the network 104. The training computing system 150 can be separate from the server computing system 130 or can be a portion of the server computing system 130.

The training computing system 150 comprises one or more processors 152 and one or more memory devices 154. The one or more processors 152 can be any suitable processing device (e.g., a processor core, a microprocessor, an ASIC, a FPGA, a controller, and/or a microcontroller) and can be one processor or a plurality of processors that are operatively connected. The one or more memory devices 154 can comprise one or more non-transitory computer-readable storage mediums, including RAM, ROM, EEPROM, EPROM, solid state drives (SSDs), and/or hard disk drives (HDDs). The one or more memory devices 154 can be configured to store the data 156 and/or the instructions 158 which can be executed by the processor 152 to cause the training computing system 150 to perform operations. In some implementations, the training computing system 150 can comprise or is implemented by one or more server computing devices.

The training computing system 150 can comprise a model trainer 160 that is configured to train the one or more machine-learning models 120 and/or the one or more machine-learning models 140 respectively stored at the computing device 102 and/or the server computing system 130 using various training or machine-learning techniques. The training or machine-learning techniques can, for example, include backwards propagation of errors. In some implementations, performing backwards propagation of errors can comprise performing truncated backpropagation through time. The model trainer 160 can perform various generalization techniques (e.g., weight decays and/or dropouts) to improve the generalization capability of the models being configured and/or trained.

In particular, the model trainer 160 can train the one or more machine-learning models 120 and/or the one or more machine-learning models 140 based on a set of training data 162. The training data 162 can comprise, for example, data associated with avatars (e.g., hierarchical skeletons, semantic segments, mesh models, and/or textures of avatars) and/or assets associated with avatars (e.g., wearable assets and/or granular assets). For example, the training data can comprise actual avatars configured by users, synthetically generated avatars, interactive entities that are implemented in a virtual environment, virtual environments that have been implemented and/or recorded, chat logs from virtual environments, three-dimensional models of virtual objects in a virtual environment, two-dimensional models of avatars, and/or user feedback based on user interactions with a virtual environment.

In some implementations, if a user has provided consent, the training examples can be provided by the computing device 102. In such implementations, the one or more machine-learning models 120 provided to the computing device 102 can be configured and/or trained by the training computing system 150 on user-specific data received from the computing device 102.

The model trainer 160 can comprise computer logic that is used to perform the operations described herein. The model trainer 160 can be implemented in hardware, firmware, and/or software controlling a general-purpose processor. In some implementations, the model trainer 160 can comprise program files stored on a storage device that are loaded into a memory and executed by one or more processors. In other implementations, the model trainer 160 can comprise one or more sets of computer-executable instructions that can be stored in a tangible computer-readable storage medium including RAM hard disk, optical media, and/or magnetic media.

In some embodiments, the training computing system 150 can perform one or more operations including generating optimized semantic segments based on assets comprising meshes and textures associated with avatars; generating hierarchical skeletons, mesh models of wearable assets, and/or facial expressions associated with mesh models of avatars; determining the compatibility of avatars with a virtual environment; and/or sending compatible avatars and granular assets associated with avatars to remote computing systems that are configured to implement the avatars within a virtual environment.

The network 104 can comprise any type of communications network, including a local area network (e.g., intranet), wide area network (e.g., Internet), or some combination thereof and can comprise any number of wired or wireless links. In general, communication over the network 104 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, and/or SSL).

FIG. 1 illustrates one example computing system that can be used to implement the present disclosure. Other computing systems can be used as well. For example, in some implementations, the computing device 102 can comprise the model trainer 160 and the training data 162. In such implementations, the one or more machine-learning models 120 can be trained and/or used locally at the computing device 102. In such implementations, the computing device 102 can implement the model trainer 160 to personalize the one or more machine-learning models 120 based on user-specific data.

FIG. 2 depicts a block diagram of an example computing device according to example embodiments of the present disclosure. A computing device 200 can comprise one or more attributes and/or capabilities of the computing device 102, the server computing system 130, and/or the training computing system 150. Furthermore, the computing device 200 can be configured to perform one or more operations and/or implement one or more applications that can be performed and/or executed by the computing device 102, the server computing system 130, and/or the training computing system 150. For example, the computing device 200 can implement an application that can access (e.g., via the Internet) a virtual environment in which a user can generate and/or configure an avatar via the computing device 200.

As described with respect to FIG. 2, the computing device 200 can comprise one or more memory devices 202, avatar data 204, asset data 206, image data 208, one or more interconnects 210, one or more processors 220, a network interface 222, one or more mass storage devices 224, one or more output devices 226, one or more sensors 228, one or more input devices 230, and/or the location device 232.

The one or more memory devices 202 can store information and/or data (e.g., the avatar data 204, the asset data 206, and/or the image data 208). Further, the one or more memory devices 202 can comprise one or more non-transitory computer-readable storage media, including RAM, ROM, EEPROM, EPROM, solid state drives (SSDs), and/or hard disk drives (HDDs). The information and/or data stored by the one or more memory devices 202 can be executed by the one or more processors 220 which can cause the computing device 200 to perform operations including generating optimized semantic segments based on assets comprising meshes and textures associated with avatars; generating hierarchical skeletons, mesh models of wearable assets, and/or facial expressions associated with mesh models of avatars; determining the compatibility of avatars with a virtual environment; and/or sending compatible avatars and granular assets associated with avatars to remote computing systems that are configured to implement the avatars within a virtual environment. Further, the computing device 200 can be configured to implement one or more machine-learning models (e.g., the one or more machine-learning models 120, the one or more machine-learning models 140, and/or the one or more machine-learning models 304).

The avatar data 204 can comprise one or more portions of data (e.g., the data 116, the data 136, and/or the data 156, which are described with respect to FIG. 1) and/or instructions (e.g., the instructions 118, the instructions 138, and/or the instructions 158 which are described with respect to FIG. 1) that are stored in the one or more memory devices 114, the one or more memory devices 134, and/or the one or more memory devices 154, respectively. Furthermore, the avatar data 204 can comprise information associated with an avatar that is used in a virtual environment. For example, the avatar data 204 can comprise an identifier of an avatar (e.g., an avatar's name), a mesh model of an avatar, textures of an avatar, a hierarchical skeleton of an avatar, and/or semantic segments of an avatar. In some embodiments, the avatar data 204 can be received from one or more computing systems (e.g., the server computing system 130 described with respect to FIG. 1) which can comprise one or more computing systems that are remote from the computing device 200.

The asset data 206 can comprise one or more portions of data (e.g., the data 116, the data 136, and/or the data 156, which are described with respect to FIG. 1) and/or instructions (e.g., the instructions 118, the instructions 138, and/or the instructions 158 which are described with respect to FIG. 1) that are stored in the one or more memory devices 114, the one or more memory devices 134, and/or the one or more memory devices 154, respectively. Furthermore, the asset data 206 can comprise information associated with assets (e.g., wearable assets and/or granular assets) that can be associated with an avatar. In some embodiments, the asset data 206 can be received from one or more computing systems (e.g., the server computing system 130 described with respect to FIG. 1) which can comprise one or more computing systems that are remote from the computing device 200.

The image data 208 can comprise one or more portions of data (e.g., the data 116, the data 136, and/or the data 156, which are described with respect to FIG. 1) and/or instructions (e.g., the instructions 118, the instructions 138, and/or the instructions 158 which are described with respect to FIG. 1) that are stored in the one or more memory devices 114, the one or more memory devices 134, and/or the one or more memory devices 154, respectively. Furthermore, the image data 208 can comprise information associated with images of an avatar that is used in a virtual environment. For example, the image data 208 can comprise images of an avatar that are captured from a variety of different perspectives and/or images in which an avatar is in various different poses (e.g., skeletal segments associated with an avatar can be configured in different positions which can result in different poses of the avatar associated with the skeletal segments). In some embodiments, the image data 208 can be received from one or more computing systems (e.g., the server computing system 130 described with respect to FIG. 1) which can comprise one or more computing systems that are remote from the computing device 200.

The one or more interconnects 210 can comprise one or more interconnects or buses that can be used to send and/or receive one or more signals (e.g., electronic signals) and/or data (e.g., the avatar data 204, and/or the asset data 206) between components of the computing device 200, including the one or more memory devices 202, the one or more processors 220, the network interface 222, the one or more mass storage devices 224, the one or more output devices 226, the one or more sensors 228 (e.g., a sensor array), the one or more input devices 230, and/or the location device 232. The one or more interconnects 210 can be arranged or configured in different ways. For example, the one or more interconnects 210 can be configured as parallel or serial connections. Further the one or more interconnects 210 can comprise: one or more internal buses that are used to connect the internal components of the computing device 200; and one or more external buses used to connect the internal components of the computing device 200 to one or more external devices. By way of example, the one or more interconnects 210 can comprise different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 220 can comprise one or more computer processors that are configured to execute the one or more instructions stored in the one or more memory devices 202. For example, the one or more processors 220 can, for example, include one or more general purpose central processing units (CPUs), application specific integrated circuits (ASICs), and/or one or more graphics processing units (GPUs). Further, the one or more processors 220 can perform one or more actions and/or operations including one or more actions and/or operations associated with the avatar data 204 and/or the asset data 206. The one or more processors 220 can comprise single or multiple core devices including a microprocessor, microcontroller, integrated circuit, and/or a logic device.

The network interface 222 can support network communications. The network interface 222 can support communication via networks including a local area network and/or a wide area network (e.g., the Internet). For example, the network interface 222 can allow the computing device 200 to communicate with the computing device 102 via the network 104.

The one or more mass storage devices 224 (e.g., a hard disk drive and/or a solid-state drive) can be used to store data including the avatar data 204 and/or the asset data 206. The one or more output devices 226 can comprise one or more display devices (e.g., LCD display, OLED display, Mini-LED display, microLED display, plasma display, and/or CRT display), one or more light sources (e.g., LEDs), one or more loudspeakers, and/or one or more haptic output devices.

The one or more sensors 228 can be configured to detect various states and can comprise one or more cameras, one or more light detection and ranging (LiDAR) devices, one or more sonar devices, and/or one or more radar devices. Further, the one or more sensors 228 can be used to provide input (e.g., an image of a user captured using the one or more cameras) that can be used as part of a security policy. In some embodiments, the one or more sensors 228 can be part of an extended reality device that a user may use to configure and/or generate an avatar and/or interact with a virtual environment.

The one or more input devices 230 can comprise a gamepad, a joystick, one or more touch sensitive devices (e.g., a touch screen display), a mouse, a stylus, one or more keyboards, one or more buttons (e.g., ON/OFF buttons and/or YES/NO buttons), one or more microphones, and/or one or more cameras (e.g., cameras that are used to capture a user's gestures which can be recognized by the computing device 200 and used to configure and/or generate an avatar within a virtual environment).

Although the one or more memory devices 202 and the one or more mass storage devices 224 are depicted separately in FIG. 2, the one or more memory devices 202 and the one or more mass storage devices 224 can be regions within the same memory module. The computing device 200 can comprise one or more additional processors, memory devices, network interfaces, which can be provided separately or on the same chip or board. The one or more memory devices 202 and the one or more mass storage devices 224 can comprise one or more computer-readable media, including, but not limited to, non-transitory computer-readable media, RAM, ROM, hard disk drives (HDDs), solid state drives (SSDs), and/or other memory devices.

The one or more memory devices 202 can store sets of instructions for applications including an operating system that can be associated with various software applications or data. For example, the one or more memory devices 202 can store sets of instructions for one or more applications to generate a virtual environment that can comprise an avatar that is configured, controlled, and/or generated via the computing device 200. In some embodiments, the one or more memory devices 202 can be used to operate or execute a general-purpose operating system that operates on mobile computing devices and/or and stationary devices, including extended reality devices, smartphones, laptop computing devices, tablet computing devices, and/or desktop computers.

The software applications that can be operated or executed by the computing device 200 can comprise applications associated with the computing device 102, the server computing system 130, and/or the training computing system 150 that are described with respect to FIG. 1. Further, the software applications that can be operated and/or executed by the computing device 200 can comprise native applications, web services, and/or web-based applications.

The location device 232 can comprise one or more devices or circuitry for determining the location of the computing device 200. For example, the location device 232 can determine an actual (e.g., latitude, longitude, and/or elevation) and/or relative position of the computing device 200 by using a satellite navigation positioning system (e.g., a GPS system, a Galileo positioning system, the GLObal Navigation satellite system (GLONASS), the BeiDou Satellite Navigation and Positioning system), and/or an inertial navigation system.

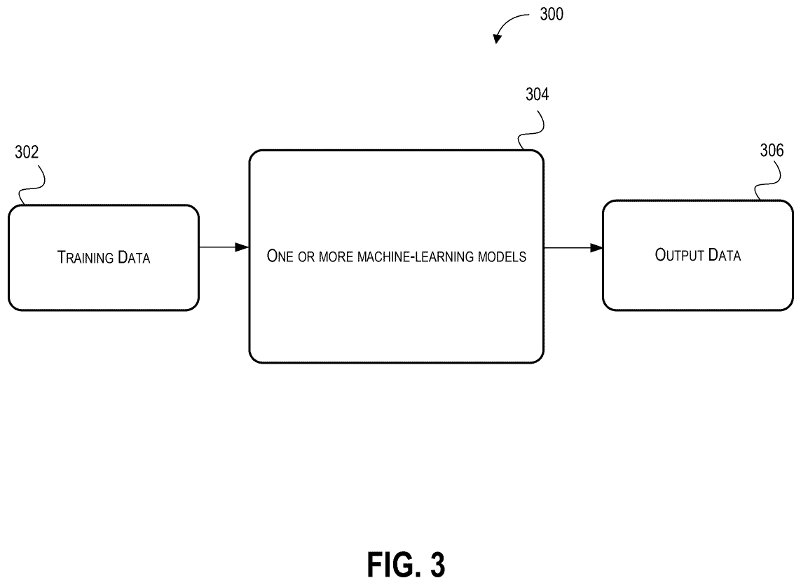

FIG. 3 depicts a diagram of an example machine-learning model according to example embodiments of the present disclosure. The machine-learning model described with respect to FIG. 3 can be generated, determined, and/or implemented by a computing system or computing device that includes one or more features of the computing device 102, the server computing system 130, and/or the training computing system 150, which are described with respect to FIG. 1; and/or the computing device 200 that is described with respect to FIG. 2. As shown in FIG. 3, the machine-learning system 300 includes training data 302, one or more machine-learning models 304, and output 306.

The training data 302 can comprise a plurality of assets (e.g., an asset associated with an avatar) which may comprise a plurality of meshes and/or textures. Further, the one or more machine-learning models 304 can be configured and/or trained to generate and/or determine a plurality of semantic segments based on input comprising the training data 302 comprising the plurality of assets. For example, a jacket asset (e.g., a two-dimensional or three-dimensional model of a jacket that may be associated with an avatar) may be inputted into the one or more machine-learning models 304 which may be configured to determine and/or generate a plurality of semantic segments associated with the jacket asset which may comprise semantic segments corresponding to the sleeves, jacket front, jacket back, and collar of the jacket asset.

The training data 302 can comprise a plurality of images (e.g., images of an avatar captured from various perspectives and/or images of an avatar in a variety of positions). Further, the one or more machine-learning models 304 can be configured and/or trained to generate and/or determine a plurality of skeletal segments corresponding to the images of the avatar based on input comprising the training data 302 comprising the plurality of images. For example, an image that captures a front view of an avatar in a standing position may be inputted into the one or more machine-learning models 304 which may be configured to determine and/or generate a plurality of skeletal segments associated with an image of the avatar which may comprise skeletal segments corresponding to the arms, legs, torso, head, and neck of the avatar captured in the image.

The training data 302 can comprise a plurality of mesh models of an avatar (e.g., two-dimensional mesh models and/or three-dimensional mesh models associated with a plurality of skeletal segments and/or a plurality of medial volumes) at a plurality of positions of the plurality of skeletal segments of the plurality of mesh models. Further, the one or more machine-learning models 304 can be configured and/or trained to generate and/or determine a plurality of skin deformations corresponding to the plurality of mesh models based on input comprising the training data 302 comprising the plurality of mesh models at the plurality of positions. For example, mesh models of an avatar with a straight arm and a bent arm may be inputted into the one or more machine-learning models 304 which may be configured to determine and/or generate a plurality of skin deformations associated with the mesh model of the avatar with a straight arm and/or bent arm.

The training data 302 can comprise a plurality of wearable assets associated with an avatar (e.g., wearable assets comprising models of clothing that can be associated with an avatar) and/or a plurality of skin deformations of an avatar (e.g., a plurality of skin deformations of an avatar in various poses). Further, the one or more machine-learning models 304 can be configured and/or trained to generate and/or determine deformable mesh model of a wearable asset based on input comprising the training data 302 comprising the plurality of wearable assets and the plurality of skin deformations of an avatar. For example, a wearable asset of an avatar may comprise a jacket asset that may be inputted into the one or more machine-learning models 304 which may be configured to determine and/or generate deformable mesh model of the jacket asset (e.g., a jacket asset with sleeves that bend when an avatar's arms bend).

The training data 302 can comprise a plurality of landmark points (e.g., a set of points corresponding to a two-dimensional or three-dimensional surface of an object). Further, the one or more machine-learning models 304 can be configured and/or trained to generate and/or determine a plurality of semantic segments corresponding to a plurality of facial features based on input comprising the training data 302 comprising the plurality of landmark points. For example, a plurality of landmark points corresponding to the facial region of an avatar may be inputted into the one or more machine-learning models 304 which may be configured to determine and/or generate a plurality of semantic segments corresponding to the plurality of facial features of the facial region of the avatar.

The one or more machine-learning models 304 can be configured and/or trained using supervised learning, unsupervised learning, reinforcement learning, and/or semi-supervised learning. Further, the one or more machine-learning models may use one or more algorithms and/or machine-learning structures including one or more neural networks (e.g., convolutional neural networks), random forest, one or more decision trees, nearest neighbors, linear regression, logistic regression, K Means clustering, and/or one or more support vector machines. Additionally, each of the one or more machine-learning models can be configured to operate alone or in combination with one or more other machine-learning models of the one or more machine-learning models 304.

The one or more machine-learning models 304 can comprise a plurality of parameters associated with weights that can be modified as the one or more machine-learning models 304 are configured and/or trained. Configuring and/or training the one or more machine-learning models 304 can comprise modifying the weights associated with the plurality of parameters based on the extent to which each of the plurality of parameters contributes to increasing or decreasing the accuracy of output generated by the one or more machine-learning models 304.

For example, the one or more machine-learning models 304 can comprise a plurality of parameters corresponding to a plurality of semantic segments associated with assets of an avatar that can be implemented in a virtual environment. In the process of training the one or more machine-learning models 304, the weighting of the plurality of parameters can be modified based on the extent to which each of the plurality of parameters contributes to accurately determining the semantic segments corresponding to assets associated with an avatar.

Configuring and/or training the one or more machine-learning models 304 can comprise the use of a cost function that can be used to minimize the error (e.g., inaccuracy) between output of the one or more machine-learning models 304 and a set of ground truth values corresponding to accurate output. For example, the training data can comprise a plurality of assets associated with an avatar. The ground-truth data may indicate values associated with semantic segments that are associated with the plurality of assets. Accurate output by the one or more machine-learning models 304 can comprise accurately determining (e.g., (e.g., identifying semantic segments that are associated with an asset and/or not identifying semantic segments that are not associated with an asset)) the semantic segments that are associated with the plurality of assets. Inaccurate output by the one or more machine-learning models 304 can comprise not accurately determining (e.g., not identifying semantic segments that are associated with an asset and/or identifying semantic segments that are not associated with an asset) the semantic segments that are associated with the plurality of assets. As the one or more machine-learning models 304 are configured and/or trained, the weighting of the plurality of parameters of the one or more machine-learning models 304 can be modified until the error associated with the output of the one or more machine-learning models 304 is minimized to a predetermined level (e.g., a level associated with generating output that is at least 98% accurate). Configuring and/or training the one or more machine-learning models 304 can be performed over a plurality of rounds and/or iterations. Further, configuring and/or training the one or more machine-learning models 304 can be concluded when a predetermined level of accuracy of the one or more machine-learning models 304 is achieved. Additionally, the one or more machine-learning models 304 can be periodically retrained based on updated training data.

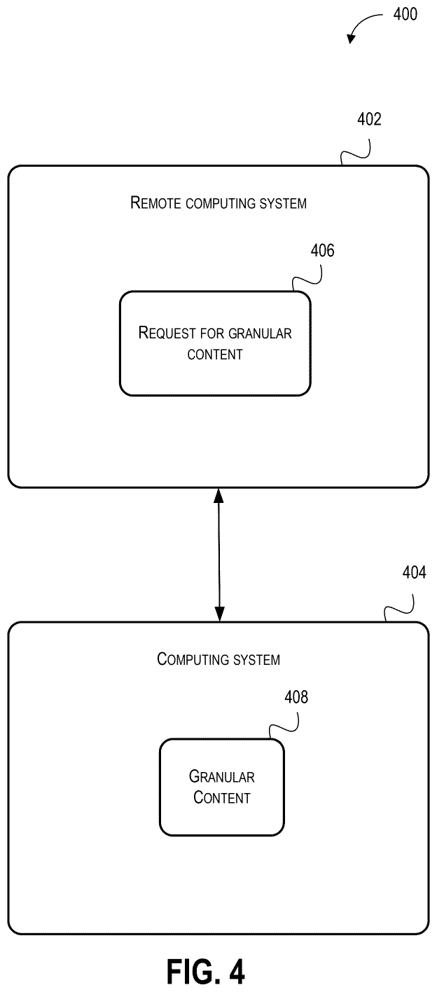

FIG. 4 depicts an example of processing granular content associated with an avatar according to example embodiments of the present disclosure. The system for processing granular assets of an avatar described with respect to FIG. 4 can be implemented on a computing system or computing device that includes one or more features of the computing device 102, the server computing system 130, and/or the training computing system 150, which are described with respect to FIG. 1; and/or the computing device 200 that is described with respect to FIG. 2. As shown in FIG. 4, the system 400 includes a request for remote computing system 402, a computing system 404, request for granular content 406, and granular content 408.

The request for granular content 406 can comprise a request for one or more assets associated with an avatar that may be stored in the computing system 404. For example, the request for granular content 406 can comprise a request for one or more assets (e.g., assets that can include wearable assets that can be associated with an avatar) that are associated with an avatar that comprises one or more traits. Further, the request for granular content 406 can comprise indications of one or more of the traits associated with the avatar. The one or more traits can comprise visual traits, kinetic traits, aural traits, and/or communication traits that can be associated with the representation of an avatar within a virtual environment.

In some embodiments, the request can indicate a particular type of granular content that is being requested. For example, the request for granular content 406 can indicate that one or more wearable assets are being requested (e.g., a request for a hat for an avatar) and/or that one or more vehicular assets (e.g., an automobile for an avatar) are being requested.

The computing system can store the granular content 408 and send the granular content to the remote computing system 402 based on the request for granular content 406. The computing system 404 can process the request for granular content 408 and determine the granular content 408 that can be sent to the remote computing system 402 based on the traits and assets indicated in the request for granular content 406. For example, if the request for granular content 406 comprises indications of traits that indicate an avatar is associated with a young child, the types of granular content 408 that can be sent to the remote computing system 402 can be different from the granular content 408 that would be sent if the avatar were associated with a mature adult. Further, the computing system 404 can be configured to generate API calls based on the request for granular content 408. The API calls can be used to request granular content that comprises one or more assets associated with the request for granular content 406.

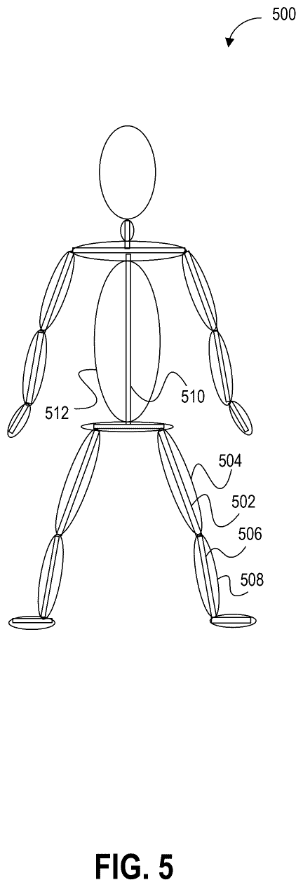

FIG. 5 depicts an example of hierarchical skeleton and medial volumes of an avatar according to example embodiments of the present disclosure. The output described with respect to FIG. 5 can be generated and/or modified by a computing system or computing device that includes one or more features of the computing device 102, the server computing system 130, and/or the training computing system 150, which are described with respect to FIG. 1; and/or the computing device 200 that is described with respect to FIG. 2. As shown, FIG. 5 depicts an avatar 500, skeletal segment 502, a medial volume 504, a skeletal segment 506, a medial volume 508, a skeletal segment 510, and a medial volume 512.

The avatar 500 can comprise the skeletal segment 502 (e.g., a virtual upper leg), skeletal segment 506 (e.g., a virtual lower leg), and skeletal segment 510 (e.g., a virtual spine). Each of the skeletal segments can be associated with a corresponding medial volume. For example, the skeletal segment 502 can be associated with medial volume 504, the skeletal segment 506 can be associated with medial volume 508, and skeletal segment 510 can be associated with medial volume 512. The medial volumes 504/508/512 can be based on a plurality of landmark points that are configured to represent a two-dimensional or three-dimensional surface. In some embodiments, the medial volumes 504/508/512 can comprise a polygonal mesh comprising vertices, edges, and faces. Further, the medial volumes 504/508/512 can be deformable. For example, the medial volumes 504/508/512 can be configured to deform based on changes in the position of the skeletal segments 502/506/510. Further, the medial volumes 504/508/512 can be configured to deform based on interaction with one or more other virtual objects (e.g., a virtual ball can cause the medial volume 512 to deform slightly when the virtual ball contacts the medial volume 512.

The skeletal segments 502/506/510 can be part of a hierarchical skeleton of the avatar 500 which can constrain the way in which the skeletal segments 502/506/510 can be positioned. For example, the skeletal segment 502 and the skeletal segment 506 are joined and a change in the position of skeletal segment 502 can result in a change in position of the skeletal segment 502.

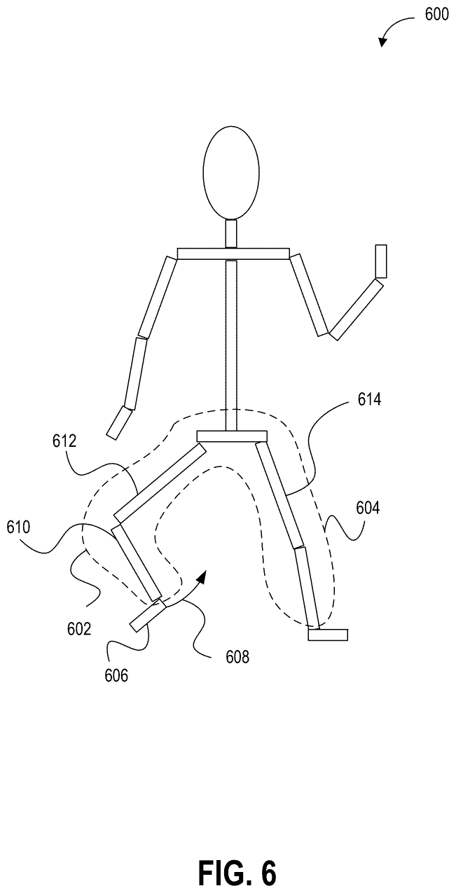

FIG. 6 depicts an example of deforming the skin of a mesh model according to example embodiments of the present disclosure. The output described with respect to FIG. 6 can be generated and/or modified by a computing system or computing device that includes one or more features of the computing device 102, the server computing system 130, and/or the training computing system 150, which are described with respect to FIG. 1; and/or the computing device 200 that is described with respect to FIG. 2. As shown, FIG. 6 depicts an avatar 600, a skin region 602, a skin region 604, a skeletal segment 606, a direction 608, a skeletal segment 610, a skeletal segment 612, and a skeletal segment 614.

The avatar 600 can comprise the skeletal segment 606 (e.g., a virtual foot), the skeletal segment 610 (e.g., a virtual lower leg), and the skeletal segment 612 (e.g., a virtual spine). Each of the skeletal segments can be associated with a corresponding medial volume (not shown). The skin regions 602/604 can be a part of a wearable asset (e.g., virtual trousers) of the avatar 600 that comprises a plurality of landmark points that are configured to represent a two-dimensional or three-dimensional surface. In some embodiments, the wearable asset associated with skin regions 602/604 can comprise a polygonal mesh comprising vertices, edges, and faces. In this example, the skeletal segments 606/610/612 can be part of a hierarchical skeleton of the avatar 600 which can cause deformations in the skin regions 602/604.

The change in position of the skeletal segment 606 (e.g., a virtual foot) in the direction 608 can result in a change in the position of the skeletal segment 606 (e.g., a virtual lower leg segment) that is connected to the skeletal segment 606 as well as a change in the position of the skeletal segment 612 (e.g., a virtual upper leg segment) that is connected to the skeletal segment 612. Further, the change in position of the skeletal segments 606/610/612 can cause the deformation of skin region 602 which is part of a wearable asset (e.g., virtual trousers). The position of the skeletal segment 614 (e.g., a virtual upper leg) does not change based on the change in the position of the skeletal segments 606/610/612 and because the skeletal segment 614 that is associated with the skin region 604 does not change position, the skin region 604 does not deform.

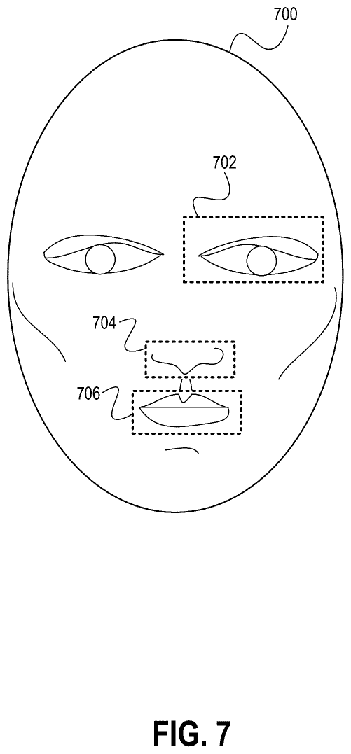

FIG. 7 depicts an example of generating facial expressions of an avatar according to example embodiments of the present disclosure. The output described with respect to FIG. 7 can be generated and/or modified by a computing system or computing device that includes one or more features of the computing device 102, the server computing system 130, and/or the training computing system 150, which are described with respect to FIG. 1; and/or the computing device 200 that is described with respect to FIG. 2. As shown, FIG. 7 depicts a facial region 700, a semantic segment 702, a semantic segment 704, and a semantic segment 706.

The facial region 700 can comprise a facial region of an avatar. The facial region 700 can comprise a plurality of landmark points that a computing system can process and/or evaluate in order to determine the semantic segments 702-706. Based on processing and/or evaluation of the plurality of landmark points of the facial region 700, a computing system can generate and/or determine the semantic segment 702 which can be associated with an eye feature of the facial region 700, the semantic segment 704 can be associated with a nose feature of the facial region 700, and/or the semantic segment 706 can be associated with a mouth feature of the facial region 700.

The semantic segments 702-706 can be used to determine facial expressions of the facial region 700. The mesh model associated with the semantic segment 702 can be modified to indicate various facial expressions. For example, the mesh model associated with the semantic segment 702 can be narrowed (e.g., the virtual eyes of the semantic segment 702 can be narrowed) or broadened to indicate various facial expressions. Further, a texture associated with the semantic segment 704 can be modified to indicate various facial states. For example, the semantic segment 704 can be reddened (e.g., the virtual nose of the semantic segment 702 can be reddened) to indicate that an avatar is cold and/or blushing. Additionally, a shape of the semantic segment 706 can be modified to indicate various facial expressions. For example, the semantic segment 706 can be deformed (e.g., the virtual mouth of the semantic segment 706 can be compressed or expanded) to indicate that an avatar is grimacing.

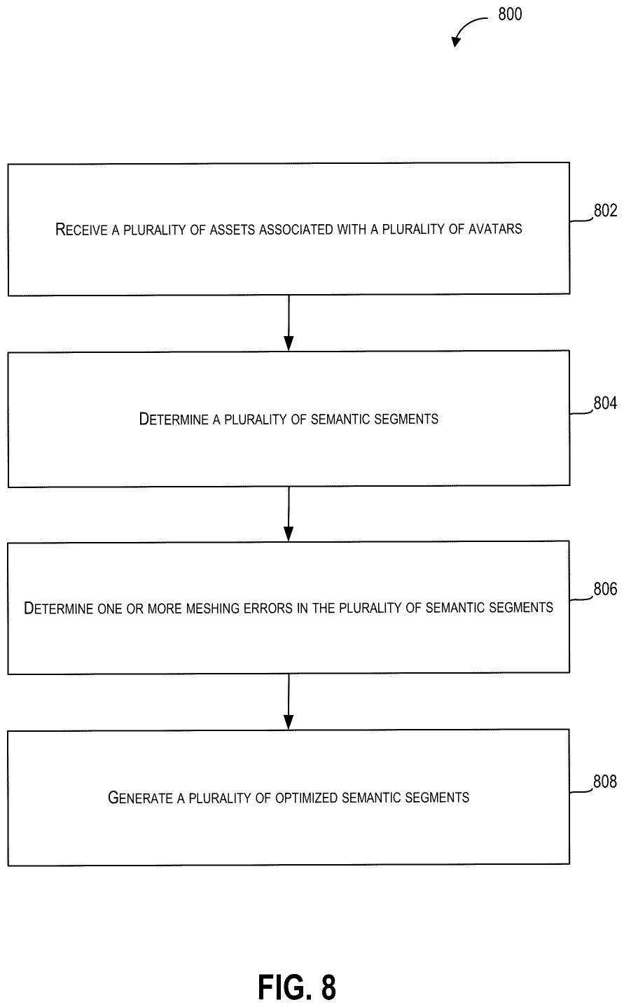

FIG. 8 depicts a flow diagram of an example method generating optimized semantic segments according to example embodiments of the present disclosure. One or more portions of the method 800 can be executed or implemented on one or more computing devices or computing systems including, for example, the computing device 102, the server computing system 130, and/or the training computing system 150; and/or the computing device 200 that is described with respect to FIG. 2. Further, one or more portions of the method 800 can be executed or implemented as an algorithm on the hardware devices or systems disclosed herein. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can comprise receiving a plurality of assets. The plurality of assets can be associated with a plurality of avatars. The plurality of assets comprise a plurality of meshes and a plurality of textures. For example, the plurality of meshes can comprise a mesh model (e.g., a two-dimensional model or three-dimensional mesh model) of a virtual object comprising virtual clothing (e.g., a virtual hat, virtual shirt, virtual coat, virtual trousers, and/or virtual shoes), virtual implements (e.g., virtual tools, virtual equipment, and/or virtual weaponry), and/or a virtual vehicle (e.g., a virtual automobile, a virtual airplane, virtual boat, and/or virtual motorcycle). Further, the plurality of assets can comprise a mesh model of an avatar. For example, the plurality of assets can comprise a mesh model of a human being, an animal (e.g., a dog, cat, or horse), and/or a fictional creature (e.g., a dragon, ghost, or elf). The plurality of textures can comprise colors (e.g., red, blue, green, black, and/or white), patterns (e.g., stripes, polka-dots, and/or checks), images (e.g., photographic images). The plurality of textures can be associated with the plurality of meshes. For example, a black textile texture can be associated with a mesh model of virtual trousers resulting in the appearance of virtual trousers with a black textile texture. For example, the computing device 102 can receive data comprising the plurality of assets via a communication network (e.g., a wireless and/or wired network which can comprise a LAN, WAN, and/or the Internet) through which one or more signals (e.g., electronic signals indicating the plurality of assets associated with a plurality of avatars) and/or data can be sent and/or received.

At 804, the method 800 can comprise determining, based on inputting the plurality of assets into one or more machine-learning models, a plurality of semantic segments of the plurality of assets. The one or more machine-learning models can be configured to generate the plurality of semantic segments based on input comprising the plurality of assets. The one or more machine-learning models can comprise a machine-learning model that is configured to analyze the plurality of meshes and a plurality of textures in order to determine the plurality of semantic segments. For example, the computing device 102 can implement one or more machine-learning models that are configured to analyze assets comprising a mesh model and associated textures of an avatar and determine the plurality of semantic segments of the mesh model that correspond to the avatar's arms, legs, torso, neck, and head. Further, the one or more machine-learning models can be configured to analyze assets and determine which semantic segments correspond to the avatar and which semantic segments correspond to virtual clothing, virtual implements, and/or virtual vehicles associated with the avatar.

At 806, the method 800 can comprise detecting, based on the plurality of meshes and/or the plurality of textures, one or more segment errors in the plurality of semantic segments. For example, the computing device 102 can analyze the plurality of semantic segments and detect one or more errors comprising the sizes of textures and/or meshes not meeting size criteria (e.g., a mesh or texture being too large or too small), the type or color of a texture not matching the semantic segment (e.g., a transparent texture being used in a semantic segment that is configured to be opaque), and/or one or more combinations of semantic segments that do not meet one or more segment combination criteria (e.g., a mesh of a foot of an avatar being connected to the torso of the avatar instead of the avatar's leg).

Detection of one or more segment errors in the plurality of semantic segments can comprise detecting segment errors associated with the resolution of the plurality of textures not satisfying one or more resolution criteria. The one or more resolution criteria may comprise a resolution of a texture note matching the dimensions of the semantic segment the texture is associated with. Further, the one or more resolution criteria may comprise a texture being within a threshold range (e.g., a texture that is 80-120% of the size of the semantic segment the texture is associated with) of the semantic segment the texture is associated with. One or more segment errors may be detected based on one or more of the plurality of textures not satisfying the one or more resolution criteria.

Detection of one or more segment errors in the plurality of semantic segments can comprise detecting segment errors associated with the size of the plurality of meshes not satisfying one or more mesh size criteria. The one or more mesh criteria may comprise a mesh size (e.g., dimensions) of a mesh being equal to (e.g., the mesh is not larger or smaller than the size of the semantic segment the mesh is associated with) the dimensions of the semantic segment the mesh is associated with. Further, the one or more mesh criteria may comprise a mesh being within a threshold range (e.g., a mesh that is 80-120% of the size of the mesh the mesh is associated with) of the semantic segment the mesh is associated with. One or more segment errors may be detected based on one or more of the plurality of meshes not satisfying the one or more mesh size criteria.

At 808, the method 800 can comprise generating, based on the one or more segment errors and the plurality of semantic segments, a plurality of optimized semantic segments. The plurality of optimized semantic segments may comprise semantic segments that do not comprise the one or more segment errors. Further, the plurality of optimized semantic segments may be based on the modification of one or more resolutions of the plurality of textures that comprise the one or more segment errors. Further, the plurality of optimized semantic segments may be based on the modification of one or more mesh sizes of the plurality of meshes that comprise the one or more segment errors. For example, based on the one or more errors that were detected, the computing device 102 can remove the one or more segment errors by modifying the plurality of semantic segments and thereby generate a plurality of optimized semantic segments that do not comprise the one or more segment errors.

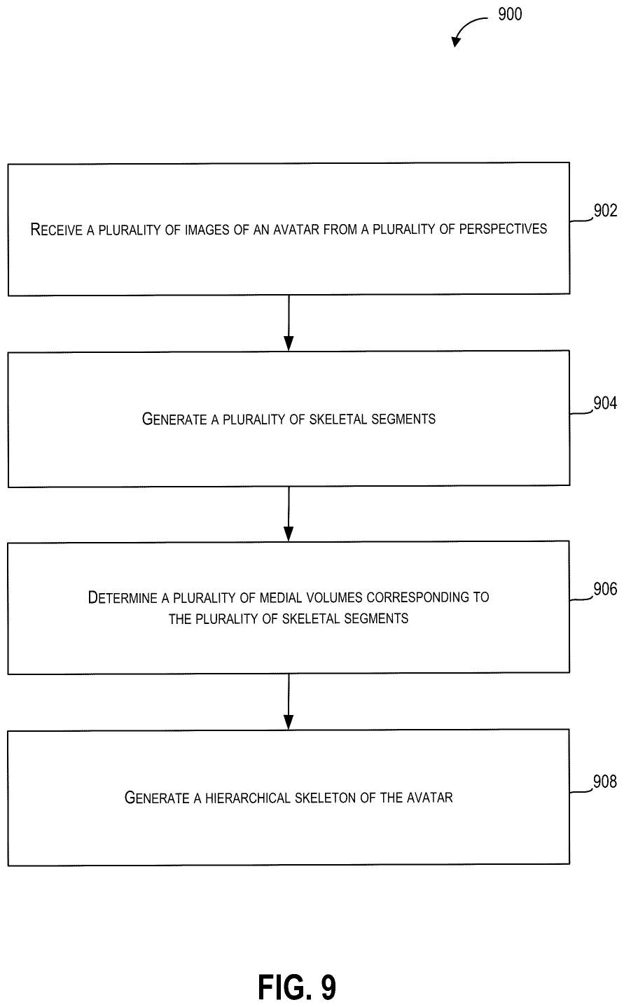

FIG. 9 depicts a flow diagram of an example method for generating a hierarchical skeleton of an avatar according to example embodiments of the present disclosure. One or more portions of the method 900 can be executed or implemented on one or more computing devices or computing systems including, for example, the computing device 102, the server computing system 130, and/or the training computing system 150; and/or the computing device 200 that is described with respect to FIG. 2. Further, one or more portions of the method 900 can be executed or implemented as an algorithm on the hardware devices or systems disclosed herein. FIG. 9 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can comprise receiving a plurality of images of an avatar. The plurality of images of an avatar can comprise a plurality of images of an avatar from a plurality of perspectives. For example, the computing device 102 can receive data comprising the plurality of images of an avatar from a plurality of perspectives via a communication network (e.g., a wireless and/or wired network which can comprise a LAN, WAN, and/or the Internet) through which one or more signals (e.g., electronic signals indicating the plurality of images of an avatar from a plurality of perspectives) and/or data can be sent and/or received.

At 904, the method 900 can comprise generating, based on inputting the plurality of images into one or more machine-learning models, a plurality of skeletal segments corresponding to the avatar. The one or more machine-learning models can be configured to generate the plurality of skeletal segments based on input comprising the plurality of images. The one or more machine-learning models can comprise a machine-learning model that is configured to process and/or analyze the plurality of images and generate the plurality of skeletal segments. For example, the computing device 102 can implement one or more machine-learning models that are configured to generate a plurality of skeletal segments that correspond to various parts of the avatar comprising a virtual head, virtual torso, and/or virtual limbs.

At 906, the method 900 can comprise determining, based on the plurality of images and the plurality of skeletal segments, a plurality of medial volumes corresponding to the plurality of skeletal segments. For example, the computing device 102 can analyze and/or evaluate the plurality of images and determine the plurality of medial volumes corresponding to the plurality of skeletal segments.

At 908, the method 900 can comprise generating a hierarchical skeleton of the avatar based on the plurality of skeletal segments and the plurality of medial volumes. For example, the computing device 102 can generate a hierarchical skeleton of the avatar based on the plurality of skeletal segments and the plurality of medial volumes that were received.

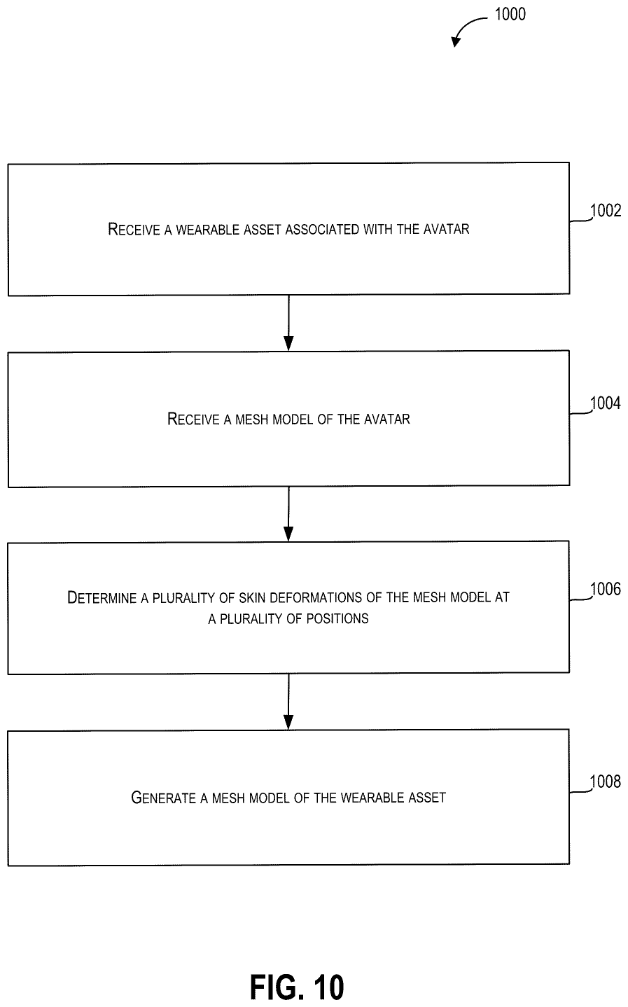

FIG. 10 depicts a flow diagram of an example method for generating a deformable mesh model of a wearable asset according to example embodiments of the present disclosure. One or more portions of the method 1000 can be executed or implemented on one or more computing devices or computing systems including, for example, the computing device 102, the server computing system 130, and/or the training computing system 150; and/or the computing device 200 that is described with respect to FIG. 2. Further, one or more portions of the method 1000 can be executed or implemented as an algorithm on the hardware devices or systems disclosed herein. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1002, the method 1000 can comprise receiving a wearable asset associated with an avatar. The plurality of wearable assets (e.g., a virtual hat or virtual jacket) can comprise a plurality of meshes and/or plurality of textures associated with the wearable assets. For example, the computing device 102 can receive data comprising a wearable asset associated with an avatar via a communication network (e.g., a wireless and/or wired network which can comprise a LAN, WAN, or the Internet) through which one or more signals (e.g., electronic signals indicating the wearable asset) and/or data can be sent and/or received.

At 1004, the method 1000 can comprise receiving a mesh model. The mesh model can comprise a mesh model of an avatar. Further, the mesh model of the avatar can be associated with a hierarchical skeleton comprising a plurality of skeletal segments and a plurality of medial volumes. For example, the computing device 102 can receive data comprising a mesh model of an avatar via a communication network (e.g., a wireless and/or wired network which can comprise a LAN, WAN, and/or the Internet) through which one or more signals (e.g., electronic signals indicating the mesh model of an avatar) and/or data can be sent and/or received.

At 1006, the method 1000 can comprise determining a plurality of skin deformations of the mesh model at a plurality of positions of the plurality of skeletal segments. The plurality of positions of the plurality of skeletal segments can correspond to modifications in one or more positions of the plurality of medial volumes that correspond to the plurality of skeletal segments. Further, the modifications of the one or more positions of the plurality of medial volumes can result in deformations (e.g., changes in shape) of the plurality of medial volumes at each of the plurality of positions of the plurality of skeletal segments. The plurality of skin deformations of the mesh model at the plurality of positions of the plurality of skeletal segments can result in the dimensions of the mesh model being different at various positions. For example, changing the position of the skeletal segments corresponding to an arm of an avatar from a straightened position to a folded position can cause deformation (e.g., the upper arm region of the arm may be flatter in the straightened position and become more rounded in the folded position) in the medial volume associated with the skeletal segments of the arm of the avatar. Determination of the plurality of skin deformations can be based on the geometry of the plurality of skeletal segments and/or plurality of medial volumes. By way of example, the computing device 102 can use the geometry of the plurality of skeletal segments and/or plurality of medial volumes to determine a plurality of skin deformations of the mesh model at a plurality of positions of the plurality of skeletal segments.

At 1008, the method 1000 can comprise generating, based on the plurality of skin deformations of the mesh model of the avatar, a deformable mesh model of the wearable asset. The deformable mesh model of the wearable asset can comprise a mesh model that has dimensions that are able to accommodate the mesh model of the avatar and which is deformable such that the deformable wearable asset deforms in a way that corresponds to the plurality of skin deformations of the mesh model of the avatar. Accommodating the mesh model of the avatar can comprise the dimensions of the deformable mesh model of the wearable asset being at least equal to the dimensions of the mesh model of the avatar at each of the plurality of positions of the plurality of skeletal segments. Further, the deformable mesh model of the wearable asset that is generated can be based on one or more size thresholds so that the wearable asset is not greater than the skeletal segment and/or medial volume corresponding to the mesh model of the avatar by more than the size threshold. For example, if the size threshold is 110%, the wearable asset can be generated so that it is not greater than 110% of the size of the skeletal segment and medial volume corresponding to the head of an avatar. The computing device 102 can use the plurality of skin deformations of the mesh model of the avatar to determine a deformable mesh model of the wearable asset that is able to accommodate the plurality of skin deformations.

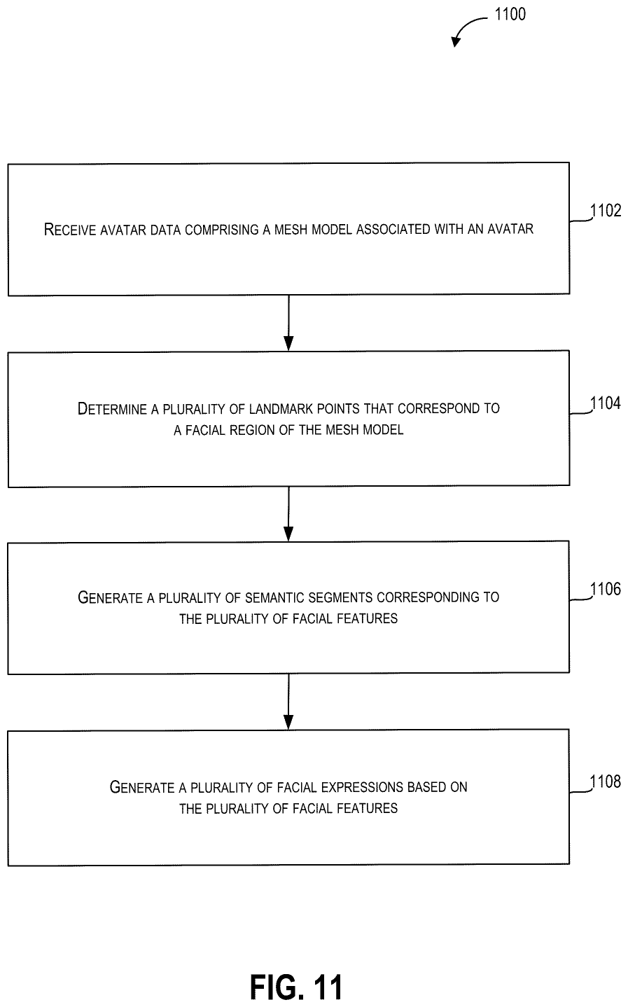

FIG. 11 depicts a flow diagram of an example method for generating facial expressions of an avatar according to example embodiments of the present disclosure. One or more portions of the method 1100 can be executed or implemented on one or more computing devices or computing systems including, for example, the computing device 102, the server computing system 130, and/or the training computing system 150; and/or the computing device 200 that is described with respect to FIG. 2. Further, one or more portions of the method 1100 can be executed or implemented as an algorithm on the hardware devices or systems disclosed herein. FIG. 11 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1102, the method 1100 can comprise receiving avatar data comprising a mesh model associated with an avatar. The mesh model can comprise a plurality of landmark points. For example, the mesh model of an avatar can comprise a two-dimensional model or three-dimensional mesh model of an avatar. The plurality of landmark points can correspond to two-dimensional or three-dimensional coordinates that indicate one or more surfaces of the avatar (e.g., an avatar's body and/or garments). For example, the computing device 102 can receive data comprising a mesh model associated with an avatar via a communication network (e.g., a wireless and/or wired network which can comprise a LAN, WAN, and/or the Internet) through which one or more signals (e.g., electronic signals indicating the mesh model of an avatar and the associated plurality of landmark points) and/or data can be sent and/or received.

At 1104, the method 1100 can comprise determining the plurality of landmark points that correspond to a facial region of the mesh model. For example, the computing device 102 can determine the plurality of landmark points that correspond to a facial region of the mesh model by clustering portions of the plurality of landmark points and analyzing the clusters to determine whether one or more shapes of the clusters correspond to a facial region of the mesh model.

At 1106, the method 1100 can comprise generating, based on inputting the plurality of landmark points that correspond to the facial region into one or more machine-learning models, a plurality of semantic segments corresponding to a plurality of facial features. For example, the computing device 102 can implement one or more machine-learning models that are configured to generate the plurality of segments corresponding to the plurality of facial features (e.g., virtual eyes, virtual nose, virtual mouth, and/or virtual chin) based on the plurality of landmark points.

At 1108, the method 1100 can comprise generating a plurality of facial expressions based on the plurality of facial features. The plurality of facial expressions comprise a plurality of configurations of the plurality of facial features. For example, the computing device 102 can generate a plurality of facial expressions based on the plurality of facial features. The plurality of facial expressions can be based on one or more predetermined expression configurations comprising smiling, frowning, laughing, weeping, furrowed brow, and/or curiosity. The predetermined expression configurations can then be applied to the facial region of the mesh model associated with the avatar.

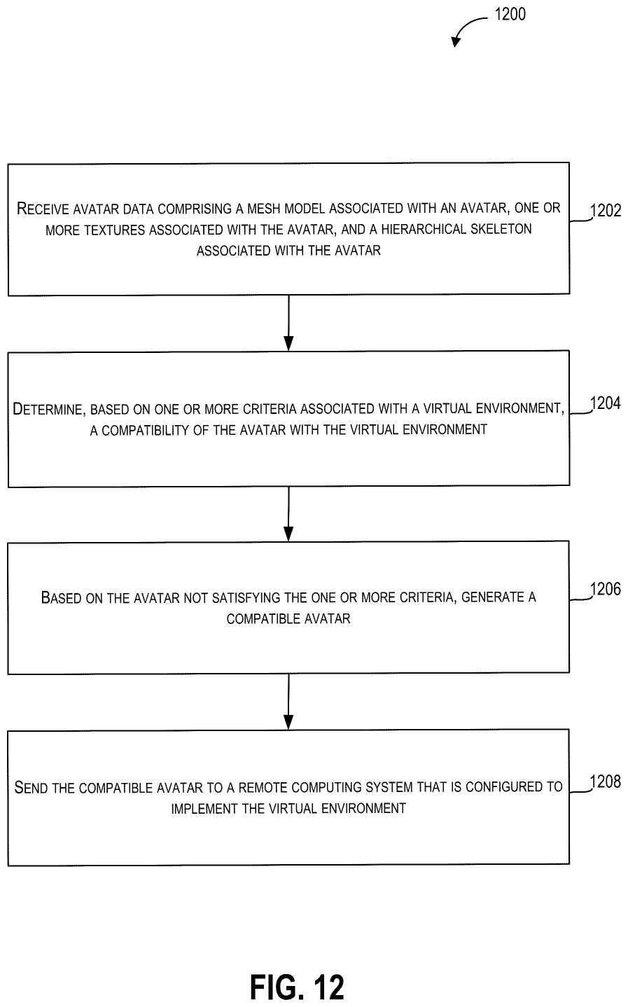

FIG. 12 depicts a flow diagram of an example method for generating compatible avatars for implementation within a virtual environment according to example embodiments of the present disclosure. One or more portions of the method 1200 can be executed or implemented on one or more computing devices or computing systems including, for example, the computing device 102, the server computing system 130, and/or the training computing system 150; and/or the computing device 200 that is described with respect to FIG. 2. Further, one or more portions of the method 1200 can be executed or implemented as an algorithm on the hardware devices or systems disclosed herein. FIG. 12 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1202, the method 1200 can comprise receiving avatar data comprising a mesh model associated with an avatar, one or more textures associated with the avatar, and/or a hierarchical skeleton associated with the avatar. For example, the avatar data can comprise a mesh model (e.g., a two-dimensional model or three-dimensional mesh model) of an avatar. Further, the one or more textures can comprise colors, depth maps, and/or patterns that can be associated with the mesh model of the avatar. Additionally, the hierarchical skeleton can indicate the directions and range of movement of one or more segments of an avatar (e.g., segments corresponding to arms, legs, a torso, and/or a head of an avatar). For example, the computing device 102 can receive data comprising the avatar data via a communication network (e.g., a wireless and/or wired network which can comprise a LAN, WAN, and/or the Internet) through which one or more signals (e.g., electronic signals indicating the avatar data) and/or data can be sent and/or received.

At 1204, the method 1200 can comprise determining, based on one or more criteria associated with a virtual environment, a compatibility of the avatar with the virtual environment. For example, the computing device 102 can determine, based on one or more criteria associated with a virtual environment, a compatibility of the avatar with the virtual environment. For example, if the one or more criteria comprise an avatar having a specific type of hierarchical skeleton (e.g., a hierarchical skeleton that can be used in a virtual environment associated with hockey) then an avatar that does not comprise the specific type of hierarchical skeleton can be determined not to be compatible with the virtual environment that requires that specific type of hierarchical skeleton.

At 1206, the method 1200 can comprise based on the avatar not satisfying the one or more criteria, generating, based on the avatar data, a compatible avatar that is compatible with the virtual environment. For example, the computing device 102 can determine the one or more criteria that the avatar did not satisfy. Based on the criteria that the avatar did not satisfy, the computing device 102 can generate a compatible avatar that satisfies the one or more criteria. For example, if an avatar did not satisfy criteria associated with a texture resolution being too large, the resolution of the avatar's textures can be reduced.

At 1208, the method 1200 can comprise sending the compatible avatar to a remote computing system that is configured to implement the virtual environment. For example, the computing device 102 can send the compatible avatar to the server computing system 130 which can be configured to implement the virtual environment.

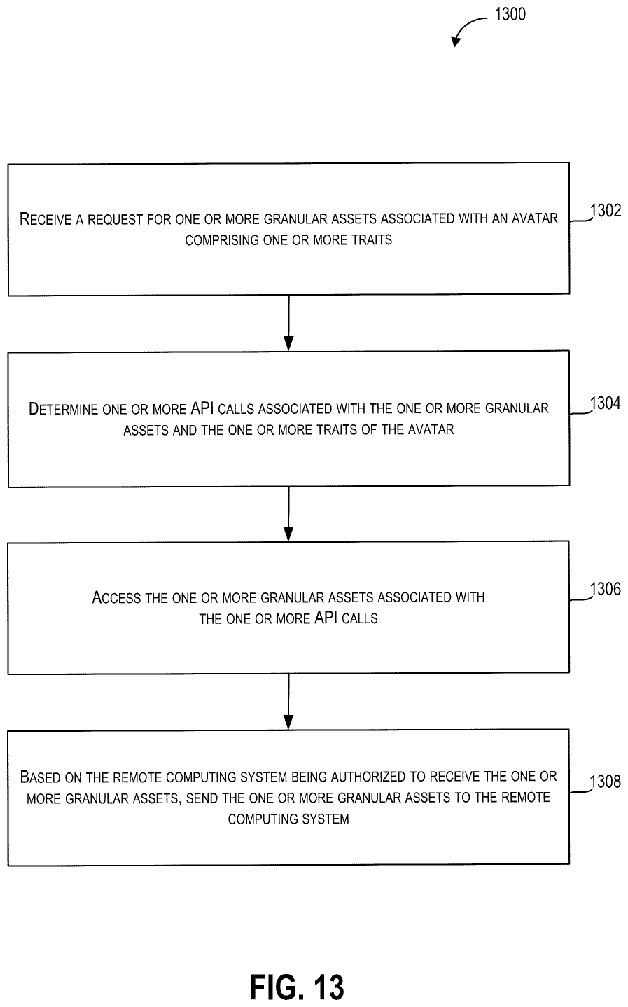

FIG. 13 depicts a flow diagram of an example method for processing granular assets associated with an avatar according to example embodiments of the present disclosure. One or more portions of the method 1300 can be executed or implemented on one or more computing devices or computing systems including, for example, the computing device 102, the server computing system 130, and/or the training computing system 150; and/or the computing device 200 that is described with respect to FIG. 2. Further, one or more portions of the method 1300 can be executed or implemented as an algorithm on the hardware devices or systems disclosed herein. FIG. 13 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1302, the method 1300 can comprise receiving, by a computing system comprising one or more processors, from a remote computing system configured to implement a virtual environment, a request for granular content comprising one or more assets associated with an avatar comprising one or more traits. For example, the computing device 102 can detect the plurality of inputs which can comprise one or more combinations of inputs (e.g., a particular sequence and/or combination of the same type of input and/or different types of inputs). Further, the computing device 102 can receive a request for granular content via a communication network (e.g., a wireless and/or wired network which can comprise a LAN, WAN, or the Internet) through which one or more signals (e.g., electronic signals indicating the plurality of inputs) and/or data can be sent and/or received.

At 1304, the method 1300 can comprise determining, based on the request, one or more application programming interface (API) calls associated with the one or more assets and the one or more traits of the avatar. For example, the computing device 102 can determine the API calls associated with the one or more assets. The computing device 102 can then determine the one or more assets that correspond to the one or more traits.

At 1306, the method 1300 can comprise accessing the one or more assets associated with the one or more API calls. For example, the computing device 102 can access the one or more assets associated with the one or more API calls. In some embodiments, the computing device 102 can access one or more assets that are not locally stored.

At 1308, the method 1300 can comprise based on the remote computing system being authorized to receive the one or more assets, sending the one or more assets to the remote computing system. For example, the computing device 102 can send the one or more assets to the remote computing system via the network 104.

The technology discussed herein makes reference to computing systems that can include servers, clients, software applications, databases, and/or other computer-based systems. Further, the technology discussed herein also makes reference to actions performed by such systems and/or information sent to and from such computing systems. The inherent flexibility of computer-based systems allows for a wide variety of possible configurations, combinations, and divisions of tasks and functionality between and among components. For instance, processes discussed herein can be implemented using a single device or component or multiple devices or components working in combination. Applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to achieve another additional embodiment. Thus, it is intended that the present disclosure covers such alterations, variations, and/or equivalents.

What is claimed is:

1. A computer-implemented method of processing avatar content, the method comprising:
receiving, by a computing system comprising one or more processors, a plurality of assets associated with a plurality of avatars, wherein the plurality of assets comprise a plurality of meshes and a plurality of textures;
determining, by the computing system, based on inputting the plurality of assets into one or more machine-learning models, a plurality of semantic segments of the plurality of assets;
detecting, by the computing system, based on the plurality of meshes and the plurality of textures, one or more segment errors in the plurality of semantic segments; and
generating, by the computing system, based on the one or more segment errors and the plurality of semantic segments, a plurality of optimized semantic segments.

2. The computer-implemented method of claim 1, wherein the one or more segment errors comprise a resolution of the plurality of textures not satisfying one or more resolution criteria, and wherein the generating, by the computing system, based on the one or more segment errors and the plurality of semantic segments, a plurality of optimized semantic segments comprises:
modifying, by the computing system, one or more resolutions of the plurality of textures to satisfy the one or more resolution criteria.

3. The computer-implemented method of claim 1, wherein the one or more segment errors comprise a mesh size of the plurality of meshes not satisfying one or more mesh size criteria, and wherein the generating, by the computing system, based on the one or more segment errors and the plurality of semantic segments, a plurality of optimized semantic segments comprises:
modifying, by the computing system, one or more mesh sizes of the plurality of meshes to satisfy one or more mesh size criteria.

4. The computer-implemented method of claim 1, wherein the plurality of semantic segments comprise one or more facial segments and one or more body segments that are different from the one or more facial segments.

5. A computer-implemented method of generating hierarchical skeletons, the method comprising:
receiving, by a computing system comprising one or more processors, a plurality of images of an avatar from a plurality of perspectives;
generating, by the computing system, based on inputting the plurality of images into one or more machine-learning models, a plurality of skeletal segments corresponding to the avatar;
determining, by the computing system, based on the plurality of images and the plurality of skeletal segments, a plurality of medial volumes corresponding to the plurality of skeletal segments; and
generating, by the computing system, a hierarchical skeleton of the avatar based on the plurality of skeletal segments and the plurality of medial volumes.

6. The computer-implemented method of claim 5, wherein the determining, by the computing system, based on the plurality of images and the plurality of skeletal segments, a plurality of medial volumes corresponding to the plurality of skeletal segments comprises:
determining, by the computing system, a plurality of medial axes corresponding to the plurality of skeletal segments.

7. The computer-implemented method of claim 5, wherein the determining, by the computing system, based on the plurality of images and the plurality of skeletal segments, a plurality of medial volumes corresponding to the plurality of skeletal segments comprises:
determining, by the computing system, a plurality of depth maps corresponding to the plurality of images.

8. The computer-implemented method of claim 5, wherein the determining, by the computing system, based on the plurality of images and the plurality of skeletal segments, a plurality of medial volumes corresponding to the plurality of skeletal segments comprises:
generating, by the computing system, a plurality of voxels based on the plurality of images and the plurality of skeletal segments; and
generating, by the computing system, the plurality of medial volumes based on application of one or more voxel thinning techniques to the plurality of voxels.

9. The computer-implemented method of claim 5, wherein the hierarchical skeleton comprises information associated with one or more ranges of motion of the plurality of skeletal segments corresponding to the avatar.

10. A computer-implemented method of generating wearable assets for avatars, the method comprising:
receiving, by a computing system comprising one or more processors, a wearable asset associated with an avatar;
receiving, by the computing system, a mesh model of the avatar, wherein the mesh model of the avatar is associated with a hierarchical skeleton comprising a plurality of skeletal segments and a plurality of medial volumes;
determining, by the computing system, a plurality of skin deformations of the mesh model at a plurality of positions of the plurality of skeletal segments; and
generating, by the computing system, based on the plurality of skin deformations of the mesh model of the avatar, a deformable mesh model of the wearable asset.

11. The computer-implemented method of claim 10, wherein the generating, by the computing system, based on the plurality of skin deformations of the mesh model of the avatar, a deformable mesh model of the wearable asset comprises:
generating, by the computing system, the mesh model of the avatar based on inputting the wearable asset and the plurality of skin deformations of the avatar into one or more machine-learning models that are configured to generate the deformable mesh model of the wearable asset.

12. The computer-implemented method of claim 10, wherein the determining, by the computing system, a plurality of skin deformations of the mesh model at a plurality of positions of the plurality of skeletal segments comprises:
determining, by the computing system, the plurality of skin deformations based on inputting the mesh model of the avatar at the plurality of positions into one or more machine-learning models that are configured to determine the plurality of skin deformations.

13. The computer-implemented method of claim 10, wherein the plurality of positions of the plurality of skeletal segments are based on one or more range of motion parameters of the hierarchical skeleton.

14. A computer-implemented method of generating facial expressions of avatars, the method comprising:
receiving, by a computing system comprising one or more processors, avatar data comprising a mesh model associated with an avatar, wherein the mesh model comprises a plurality of landmark points;
determining, by the computing system, the plurality of landmark points that correspond to a facial region of the mesh model;
generating, by the computing system, based on inputting the plurality of landmark points that correspond to the facial region into one or more machine-learning models, a plurality of semantic segments corresponding to a plurality of facial features; and
generating, by the computing system, a plurality of facial expressions based on the plurality of facial features, wherein the plurality of facial expressions comprise a plurality of configurations of the plurality of facial features.

15. The computer-implemented method of claim 14, wherein the plurality of configurations of the plurality of facial features comprise a plurality of different spatial relationships of the plurality of facial features.

16. The computer-implemented method of claim 14, wherein the generating, by the computing system, the plurality of facial expressions based on the plurality of facial features, wherein the plurality of facial expressions comprise a plurality of configurations of the plurality of facial features comprises:
modifying, by the computing system, a plurality of spatial relationships of the plurality of facial features.

17. The computer-implemented method of claim 14, wherein the plurality of landmark points are based on one or more real-world facial features detected by one or more sensors.

18. A computer-implemented method of processing avatars, the method comprising:
receiving, by a computing system comprising one or more processors, avatar data comprising a mesh model associated with an avatar, one or more textures associated with the avatar, and a hierarchical skeleton associated with the avatar;
determining, by the computing system, based on one or more criteria associated with a virtual environment, a compatibility of the avatar with the virtual environment;
based on the avatar not satisfying the one or more criteria, generating, by the computing system, based on the avatar data, a compatible avatar that is compatible with the virtual environment; and
sending, by the computing system, the compatible avatar to a remote computing system that is configured to implement the virtual environment.

19. The computer-implemented method of claim 18, wherein the one or more criteria comprise a mesh format of the mesh model matching a mesh format of the virtual environment, and wherein the generating, by the computing system, based on the avatar data, a compatible avatar that is compatible with the virtual environment comprises:
modifying, by the computing system, the mesh format of the mesh model to match the mesh format of the virtual environment.

20. The computer-implemented method of claim 18, wherein the generating, by the computing system, based on the avatar data, a compatible avatar that is compatible with the virtual environment comprises:
modifying, by the computing system, the hierarchical skeleton associated with the avatar.

21. The computer-implemented method of claim 18, wherein the one or more criteria comprise a texture format of the one or more textures matching a texture format of the virtual environment, and wherein the generating, by the computing system, based on the avatar data, a compatible avatar that is compatible with the virtual environment comprises:
modifying, by the computing system, the texture format of the one or more textures to match the texture format of the virtual environment.

22. A computer-implemented method of processing avatar content, the method comprising:
receiving, by a computing system comprising one or more processors, from a remote computing system configured to implement a virtual environment, a request for granular content comprising one or more assets associated with an avatar comprising one or more traits;
determining, by the computing system, based on the request, one or more application programming interface (API) calls associated with the one or more assets and the one or more traits of the avatar;
accessing, by the computing system, the one or more assets associated with the one or more API calls; and
based on the remote computing system being authorized to receive the one or more assets, sending, by the computing system, the one or more assets to the remote computing system.

23. The computer-implemented method of claim 22, wherein the granular content comprises one or more textures that are configured to overlay a mesh model of the avatar.

24. The computer-implemented method of claim 22, wherein the granular content comprises one or more wearable assets that are configured to overlay a mesh model of the avatar.
